(19) United States
(12) Patent Application Publication
(10) Pub. No.: US 2026/0314781 A1
(43) Pub. Date: Oct. 15, 2026

(54) CASE AND TROLLEY ASSEMBLY

(71) Applicant: Marcus McCollum, Spokane, WA (US)

(72) Inventor: Marcus McCollum, Spokane, WA (US)

(21) Appl. No.: 19/176,433

(22) Filed: Apr. 11, 2025

(51) Int. Cl. A45C 13/38; G06F 1/18

(52) U.S. Cl. CPC A45C 13/385; G06F 1/181

(57) ABSTRACT

An assembly includes a trolley and a case removably coupled to the trolley. The case is configured to transition between a closed state and an open state. The case has a housing, a lid rotatably coupled to the housing, first computing components disposed within the housing, at least one second computing component disposed within the lid, the at least one second computing component communicatively coupled to at least one of the first computing components. The first computing components include at least a central processing unit (CPU), a graphics processing unit (GPU), a power supply, a motherboard, and one or more fans. The at least one second computing component includes a display. A grill is disposed along a bottom of the housing and permits an intake of air via the one or more fans.

### BACKGROUND

Computers are used for various purposes, such as business, work, or pleasure. One area in which computers have been increasingly used is for gaming. These devices have increased in computing performance and graphic capabilities to enable positive experiences for their users. However, these devices are often bulky in nature and not easily transportable. While portable devices exist, these portable devices often sacrifice computing performance and/or graphic capabilities. Moreover, portable devices are often prone to overheating.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale and components within the figures may be depicted not to scale with each other.

FIG. 1 illustrates an isometric view of an example case and a trolley, according to an embodiment of the present disclosure.

FIG. 2 illustrates a side view of the case and the trolley of FIG. 1, according to an embodiment of the present disclosure.

FIG. 3 illustrates a side view of the case and the trolley of FIG. 1, according to an embodiment of the present disclosure.

FIG. 4 illustrates an isometric view of an example case with the trolley of FIG. 1, according to an embodiment of the present disclosure.

FIG. 5 illustrates an isometric view of the trolley of FIG. 1, according to an embodiment of the present disclosure.

FIG. 6 illustrates a side view of the trolley of FIG. 1, according to an embodiment of the present disclosure.

FIGS. 7A and 7B illustrate example coupling mechanisms of the trolley of FIG. 1, for securing the case of FIG. 1 or the case of FIG. 4, according to an embodiment of the present disclosure.

FIG. 8 illustrates a coupling mechanism of the case of FIG. 1 that engages with one of the coupling mechanisms of FIGS. 7A and 7B, according to an embodiment of the present disclosure.

FIG. 9A illustrates an engagement between the case of FIG. 1 and the trolley of FIG. 1, according to an embodiment of the present disclosure.

FIG. 9B illustrates an engagement between the case of FIG. 4 and the trolley of FIG. 1, according to an embodiment of the present disclosure.

FIG. 10 illustrates a front isometric view of the case of FIG. 1, showing the case in a closed state, according to an embodiment of the present disclosure.

FIG. 11 illustrates a side view of the case of FIG. 1, showing the case in a closed state, according to an embodiment of the present disclosure.

FIG. 12 illustrates a rear isometric view of the case of FIG. 1, showing the case in a closed state, according to an embodiment of the present disclosure.

FIG. 13 illustrates a side view of the case of FIG. 1, showing the case in a closed state, according to an embodiment of the present disclosure.

FIGS. 14A-14C illustrates various bottom isometric views of the case of FIG. 1, showing the case in a closed state, according to an embodiment of the present disclosure.

FIG. 15 illustrates the coupling mechanism FIG. 8, according to an embodiment of the present disclosure.

FIG. 16 illustrates an example sequence for engaging the coupling mechanism of FIG. 8 with the coupling mechanism of FIGS. 7A and 7B, according to an embodiment of the present disclosure.

FIG. 17 illustrates a front isometric view of the case of FIG. 1, showing the case in an open state, according to an embodiment of the present disclosure.

FIG. 18 illustrates a front isometric view of the case of FIG. 1, showing the case in an open state and example computing components disposed within the case, according to an embodiment of the present disclosure.

FIG. 19 illustrates a top view of the case of FIG. 1, showing the case in an open state, according to an embodiment of the present disclosure.

FIGS. 20A-20E illustrate various side views of the case of FIG. 1, showing the case in an open state, according to an embodiment of the present disclosure.

FIGS. 21A and 21B illustrate example covers of the case of FIG. 1, according to an embodiment of the present disclosure.

FIGS. 22A-22E illustrate various top and side views of the case of FIG. 4, showing the case in a closed state, according to an embodiment of the present disclosure.

FIGS. 23A and 23B illustrate bottom views of the case of FIG. 4, showing the case in a closed state, according to an embodiment of the present disclosure.

FIGS. 24A and 24B illustrate views of the case of FIG. 4, showing the case in an open state and example computing components disposed within the case, according to an embodiment of the present disclosure.

FIGS. 25A-25E illustrate various side views of the case of FIG. 4, showing the case in an open state, according to an embodiment of the present disclosure.

FIG. 26 illustrates an example cover of the case of FIG. 4, according to an embodiment of the present disclosure.

FIG. 27 illustrates a side view of an example lid of the case of FIG. 4, according to an embodiment of the present disclosure.

FIG. 28 illustrates a side view of the lid of FIG. 27, according to an embodiment of the present disclosure.

FIG. 29 illustrates an example bracket coupled to a display of the case of FIG. 4, according to an embodiment of the present disclosure.

FIG. 30 illustrates an example coupling of the bracket of FIG. 29 to the lid of FIG. 27, according to an embodiment of the present disclosure.

FIGS. 31A and 31B illustrate example computing components and an example frame configured to couple the computing components to the case of FIG. 1 or the case of FIG. 4, according to an embodiment of the present disclosure.

FIGS. 32A and 32B illustrate the frame of FIGS. 31A and 31B, according to an embodiment of the present disclosure.

### DETAILED DESCRIPTION

This application is directed, at least in part, to a case and trolley assembly, according to an embodiment of the present disclosure. The case may contain one or more computing components, such as cooling components, central processing units (CPUs), graphics processing units (GPUs), displays, power adapters, etc. The one or more computing components may be coupled to the case to secure the one or more computing components within the case. The case may transition between a closed state in which access to the one or more computing components is restricted and an open state in which access to the one or more computing components is permitted. The trolley may be used to transport the case between locations. In an embodiment, the trolley and the case may include one or more coupling mechanisms that engage with one another to secure the case and trolley together during transport. After being transported, for example, the one or more coupling mechanisms may disengage to uncouple the case from the trolley. Therein, the case may transition to the open state to permit access and/or use of the one or more computing components. The case and trolley assembly, as described herein, may be easily transported, have a compact footprint, and securely store the one or more computing components.

The case may represent any suitable case, container, enclosure, cabinet, etc. The case may include a housing and a lid that hingedly couples to the housing. The lid may move between positions to permit access to an interior cavity in which the one or more computing components are disposed. For example, in a first position of the lid, the case may be in the closed state. In the first position, the lid may secure to the housing via one or more latching mechanisms. The one or more latching mechanisms may maintain the case in the closed state. For example, the latching mechanisms may span between the lid and the housing to prevent opening of the lid. In a second position of the lid, the case may be in the open state. Here, the one or more latching mechanisms may be disengaged from the housing, for example, to permit opening of the lid. In addition to the one or more latching mechanisms, one or more locking mechanisms (e.g., keypads, digital locks, key locks, etc.) may also secure the case in the closed state. For example, a locking mechanism may lock the lid and the housing together to prevent the lid moving to the second position.

As introduced above, the computing components may be disposed within the interior cavity of the case. In an embodiment, the interior cavity may be defined at least in part by the lid and the housing. In an embodiment, first computing components may be disposed within a portion of the interior cavity defined by the housing, and second computing components may be disposed within a portion of the interior cavity defined by the lid. In an embodiment, the portion of the interior cavity defined by the housing may be larger in volume than that of the interior cavity defined by the lid. The first computing components and the second computing components may communicatively couple together via cables, cords, flex circuits, etc., that route between the housing and the lid.

In an embodiment, and as non-limiting examples, the first computing components may include cooling components (e.g., fans), CPUs, GPUs, power adapters, memory, motherboards, etc. The first computing components may be mounted within the housing, for example, using various brackets, mounts, clamps, fasteners, adhesives, etc. The first computing components may be disposed within, about, etc., the housing to form a compact enclosure. For example, the first computing components may be arranged in a stacked orientation, side-by-side, etc., to permit the first computing components to be disposed within the housing.

The first computing components may be mounted to walls of the housing (e.g., along the side, bottom, etc.). In addition, apertures may be formed in, or through, one or more of the walls of the housing to permit cooling of the first computing components. For example, an aperture may be formed along a bottom of the housing, a back of the housing, etc., to draw air into the interior cavity. The air may vent from a top of the housing, which is open to an environment, in the open state of the case. Grates, grills, etc., may be disposed over the apertures to provide the case with a clean and aesthetic appearance.

The second computing components may include at least a display or monitor. The display may be visible in the open state of the case and as the lid moves to the second position. In an embodiment, the display may mount to the lid via a bracket that permits the display to be easily swapped out or interchanged with other displays. In addition, the bracket permits the display to be reoriented in one or more directions (e.g., up and down, side to side, etc.) and/or about one or more axes (e.g., tilt, pan, yaw).

Various buttons (e.g., on/off), ports (e.g., Power, USB, etc.), connections, jacks, etc., may be disposed about the housing and/or the lid. In an embodiment, the buttons, ports, connections, jacks, etc., may be accessible on an exterior of the housing and/or the lid. In an embodiment, apertures, slots, channels, receptacles, etc., may be formed in the walls of the housing to provide access to the buttons, ports, connections, jacks, etc. The computing components of the case may communicatively couple to other I/O components, such as a keyboard, a mouse, etc., whether wireless or through wired connections. Additional computing components may include lighting elements that illuminate according to an operational state, speakers that output sound, microphones that capture audio, etc.

In an embodiment, the case may be manufactured from plastic, composites, metal, and/or any combination thereof. The case may include any suitable size. For example, the case may be sixteen inches in length, eighteen inches in length, twenty two includes in length, etc. Additional components of the case may include handles, gussets for strength and rigidity, etc. Still, feet may be disposed along the bottom of the case to offset the bottom of the case from a surface (e.g., table, desk, etc.) on which the case is disposed. The feet may maneuver from a collapsed position to an extended position. In the collapsed position, the feet may substantially lay flat along the bottom of the case, such as during transport of the case. In the extended position, the feet may prop the bottom of the case from the surface. The feet may be adjustable to accommodate preferences of a user. Any number of the feet may be disposed along the bottom. Moreover, the feet may permit air to be drawn in by the fans to cool the computing components within the case.

As introduced above, the trolley may be used to transport the case. In an embodiment, the housing may include a first coupling mechanism that engages with a second coupling mechanism of the trolley. An engagement between the first coupling mechanism and the second coupling mechanism may secure the case to the trolley. In an embodiment, the first coupling mechanism and the second coupling mechanism may represent any suitable male/female connector, key/keyway connector, tab, flange, slot, slit, etc., that engage with one another to secure the case to the trolley together. In an embodiment, the first coupling mechanism and the second coupling mechanism may engage via rotation or translational movement.

As a non-limiting example, the first coupling mechanism may include a shaft having a head, and the second coupling mechanism may have a receptacle with interlocking jaws. The head may be insertable into the receptacle. The interlocking jaws may engage the head to retain the head within the interlocking jaws or, more generally, the receptacle. This engagement prevents a disengagement between the housing and the trolley. A button, lever, arm, etc., may be actuated to release the case from the trolley. At this instance, the interlocking jaws may retract, thereby permitting the head to be removed from the receptacle. When the head is permitted to be removed, the case may be removed from the trolley. However, although described as decoupling from the trolley, in an embodiment, the case may remain secured to the trolley and/or the computing components in the case may be operational when the case is coupled to the trolley. In such instances, the case and the trolley may be integrated within a single component.

In an embodiment, other features of the case and the trolley may engage to situate, orient, etc., the case on the trolley. For example, alignment mechanisms may align the case on the trolley. These alignment mechanisms may serve to align the first coupling mechanism and the second coupling mechanism. For example, in an embodiment, flanges on the trolley may engage with flanges on the housing to align the housing on the trolley, and/or prevent a reorientation of the case when situated on the trolley. Further, straps, bands, etc., may be used to secure the case and the trolley together.

In an embodiment, the housing and/or the trolley may include more than one of the first coupling mechanisms and the second coupling mechanism, respectively. For example, the trolley may include two of the second coupling mechanisms to accommodate differently sized cases. Here, the trolley may include two of the second coupling mechanisms to engage with a first coupling mechanism of a first case (e.g., a sixteen-inch case) and a first coupling mechanism of a second case (e.g., an eighteen-inch case, twenty two inch case, etc.). Although only one of the cases may be secured to the trolley at a particular instance in time, the inclusion of two of the second coupling mechanisms may allow the trolley to be used universally with differently sized cases. Further, multiple first coupling mechanisms and multiple second coupling mechanisms may engage, respectively, to increase securement between the housing and the trolley.

The trolley may represent any suitable transport mechanism, such as a dolly, cart, etc. The trolley may include a base on which the case may rest and a frame. The frame may include the second coupling mechanism. In addition, a handle may extend from the frame. The handle may telescopically extend from and retract into the frame to reduce the size of the trolley when not in use. The base may also fold inward so as to be disposed against the frame. The trolley may include any number of wheels to allow for convenient transport. The wheels may be disposed along the frame and/or the base. The wheels may rotate about one or more axes.

The case and trolley, as described herein, may be usable for any purpose. For example, the computing components of the case may represent a portable, compact, etc., mobile desktop. The case and trolley may be used for gaming applications, virtual reality applications, etc. The case, or the computing components within the case, may also externally connect to monitors, TVs, displays, projectors, etc., whether through wired or wireless connections. The portable nature of the case may provide users with increased flexibility, convenience, and use. In an embodiment, the case may be sized to reside in overhead compartments of airplanes, buses, trains, etc.

Although certain components of the case and the trolley are described, the case and/or the trolley may include additional or alternative components. In such instances, the case and/or the trolley may be configured accordingly. Regardless, the computing components may compactly and securely fit within the case to provide increased portability.

The present disclosure provides an overall understanding of the principles of the structure, function, device, and system disclosed herein. One or more examples of the present disclosure are illustrated in the accompanying drawings. Those of ordinary skill in the art will understand and appreciate that the devices, the systems, and/or the methods specifically described herein and illustrated in the accompanying drawings are non-limiting embodiments. The features illustrated or described in connection with one embodiment or instance may be combined with the features of other embodiments or instances. Such modifications and variations are intended to be included within the scope of the disclosure and appended claims.

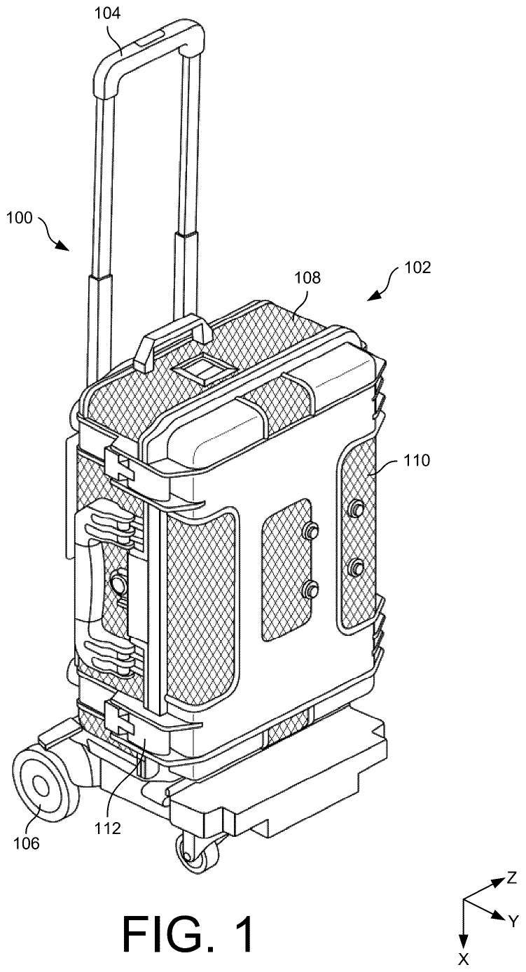

FIG. 1 illustrates an isometric view of a trolley 100 and a case 102, according to an embodiment of the present disclosure. In an embodiment, the trolley 100 and the case 102 may be collectively referred to herein as an assembly, a system, etc. As shown in FIG. 1, the case 102 is coupled to the trolley 100. As will be explained herein, the case 102 may be coupled to the trolley 100 to secure, attach, etc., the case 102 to the trolley 100. The trolley 100 may be used to conveniently transport the case 102 between locations. The trolley 100, for example, may include a handle 104 that telescopically extends from and into a frame of the trolley 100. The trolley 100 may also include one or more wheels 106 to allow the trolley 100 to roll across a surface (e.g., floor).

The case 102, as will be explained herein, may include a housing 108 and a lid 110 coupled to the housing 108. The case 102 may transition between a closed state, as shown in FIG. 1, to an open state. In the open state, computing components within the case 102 are accessible. In an embodiment, the case 102 may transition to the open state after decoupling the case 102 from the trolley 100. One or more latches 112 may engage the housing 108 and lid 110 to prevent inadvertent access to the computing components.

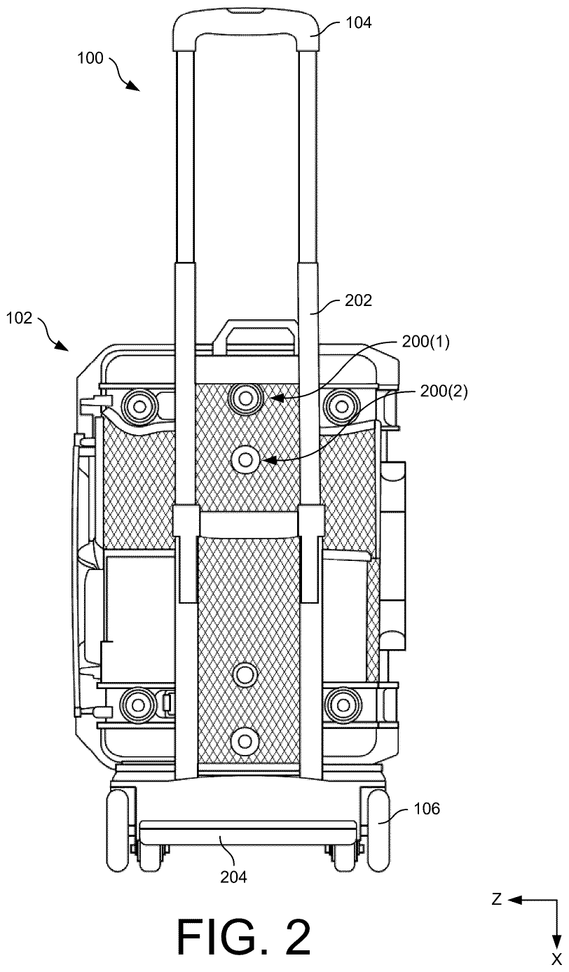

FIG. 2 illustrates a side view of the trolley 100 and the case 102, according to an embodiment of the present disclosure. In an embodiment, the view shown in FIG. 2 illustrates a rear view of the trolley 100 and a bottom view of the case 102.

As introduced above in FIG. 1, the trolley 100 and the case 102 may couple together to secure the case 102 to the trolley 100. In an embodiment, the trolley 100 may include coupling mechanisms 200 that engage with the case 102. In an embodiment, the trolley 100 may have a coupling mechanism 200(1) and a coupling mechanism 200(2). The coupling mechanism 200(1) may engage a corresponding coupling mechanism of the case 102. The coupling mechanism 200(2) may engage a corresponding coupling mechanism of another case. For example, the case 102 may have a first size (e.g., eighteen inches) that is different than a second size of the other case (e.g., sixteen inches). However, other sizes of the case 102 are envisioned (e.g., twenty two inches). In this sense, the trolley 100 may be used to transport cases of different sizes, configurations, etc. In FIG. 2, the coupling mechanism 200(1) may be in use, while the coupling mechanism 200(2) may not be in use.

The trolley 100 may additionally include the handle 104 that telescopically extends (e.g., in the X-direction) from and retracts into a frame 202 of the trolley 100. The frame 202 may hingedly couple to a base 204 of the trolley 100. The hinged nature of the base 204 relative to the frame 202 permits the base 204 to be folded up (e.g., about the Z-axis) when the case 102 is uncoupled from the trolley 100. This may reduce a footprint of the trolley 100. The wheels 106 may be disposed on the base 204.

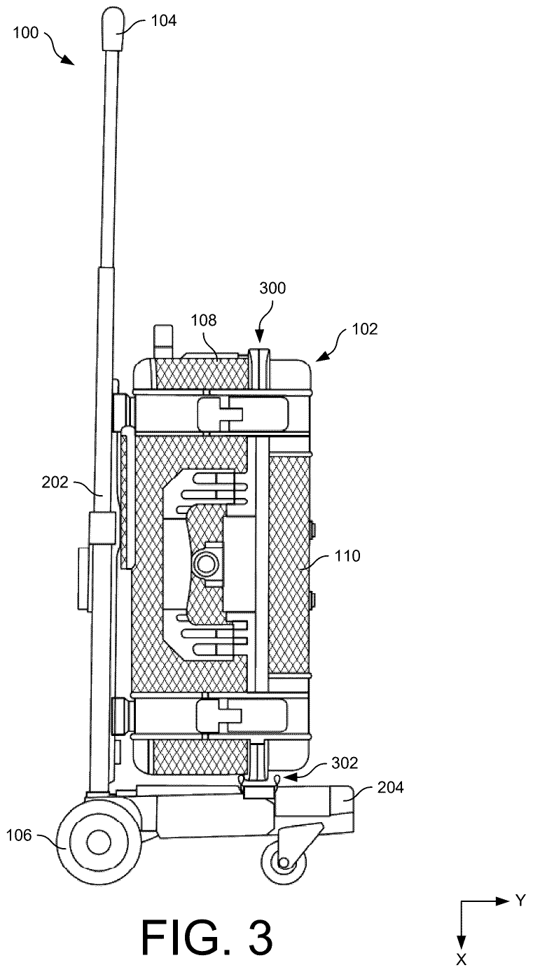

FIG. 3 illustrates a side view of the trolley 100 and the case 102, according to an embodiment of the present disclosure. In an embodiment, the view shown in FIG. 3 illustrates a right side view of the trolley 100 and a front view of the case 102.

The trolley 100 includes the frame 202, the base 204, which has the wheels 106, and the handle 104 that telescopically extends from the frame 202. The base 204 may define a platform on which a side of the case 102 rests or is disposed. For example, the case 102 may include a flange 300 formed at least in part by the housing 108 and the lid 110. In the closed state of the case 102, the flange 300 is disposed at or along an intersection of the housing 108 and the lid 110. In an embodiment, the flange 300 is disposed within a channel 302 on the base 204. Disposition of the flange 300 within the channel 302 may help to seat the case 102 on the base 204, and/or prevent a reorientation of the case 102 during transport. In other words, an engagement between the flange 300 and the channel 302 may help to secure the case 102 to the trolley 100.

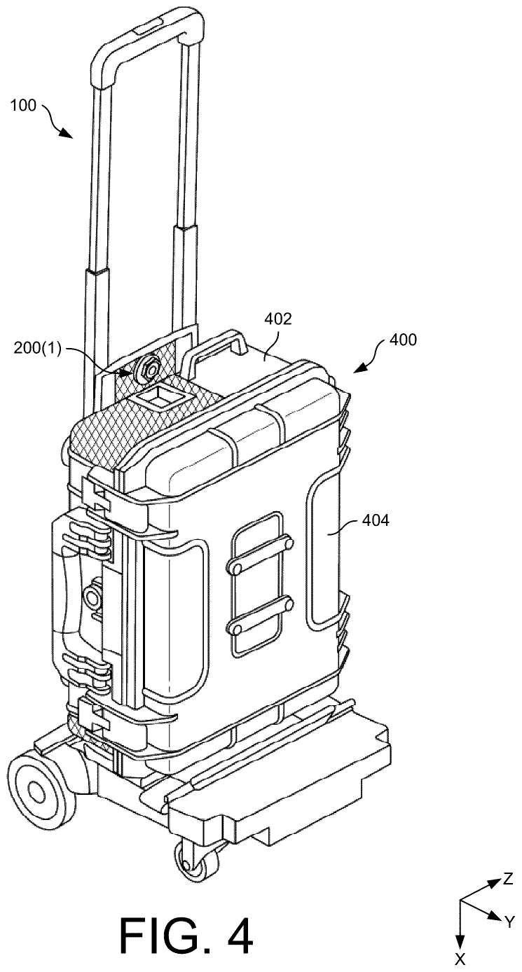

FIG. 4 illustrates an isometric view of the trolley 100 and a case 400, according to an embodiment of the present disclosure. As introduced above, the trolley 100 may be configured to hold different cases, such as differently sized cases, differently configured cases, etc. For example, the case 102 may represent a first type of case and the case 400 may represent a second type of case. The first type of case and the second type of case may be similar and/or different in multiple regards. In an embodiment, the case 102 may be a first size of case (e.g., eighteen inches in length in the X-direction) and the case 400 may be a second size of case (e.g., sixteen inches in length in the X-direction) that is different than the first size of case. In other respects, and as will be explained herein, the case 400 may be similar to the case 102. For example, the case 400 may include a housing 402 and a lid 404. As shown in FIG. 4, the coupling mechanism 200(1) may not be used, given that the coupling mechanism 200(2) is utilized to secure the case 400 to the trolley 100.

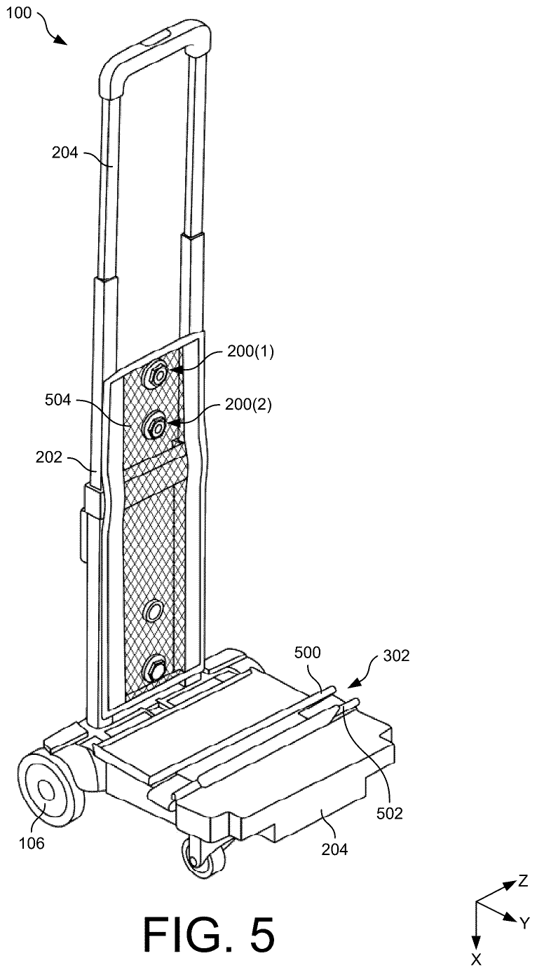

FIG. 5 illustrates an isometric view of the trolley 100, showing the case 102 and the case 400 removed, according to an embodiment of the present disclosure. As introduced above, the trolley 100 includes the handle 104, the frame 202, the base 204, and the wheels 106. The base 204 is configured to fold inwards (e.g., about the Z-axis) towards the frame 202 to reduce a footprint of the trolley 100 when not in use. The base 204 may hingedly couple to the frame 202.

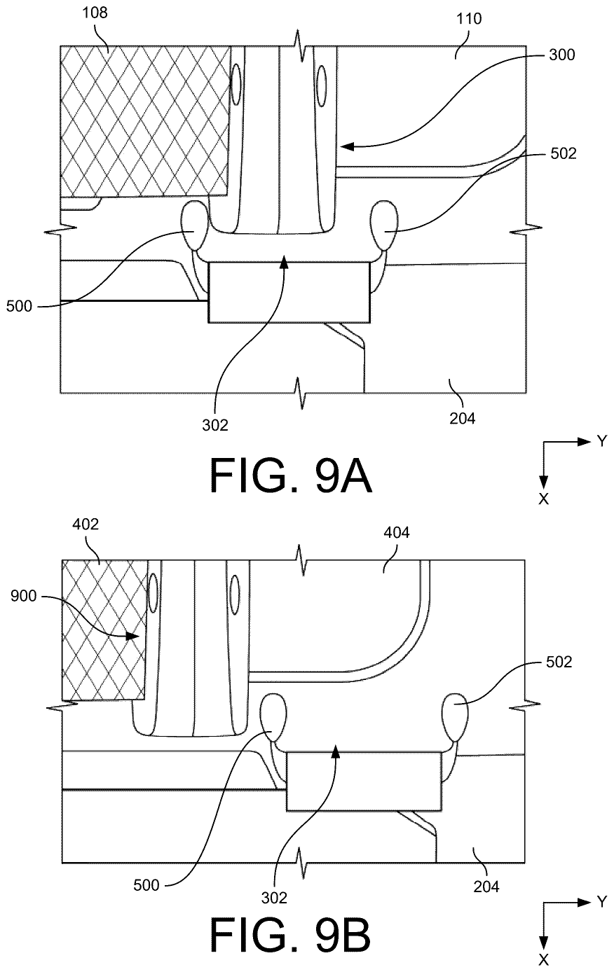

The base 204 includes the channel 302, which has a first sidewall 500 and a second sidewall 502, for engaging with features of the case 102 and/or the case 400. For example, as will be shown in FIGS. 9A and 9B, the flange 300 of the case 102 (or a similar flange of the case 400) may be disposed within the channel 302, between the first sidewall 500 and the second sidewall 502. The channel 302 may be formed via a piece of extruded material that couples to, or is integrated with, the base 204.

The frame 202 may include a shroud 504, which may protect components of the case 102 and/or the case 400. For example, the shroud 504 may protect fans, I/O components, etc., disposed within, along, in, or on the case 102 and/or the case 400. The coupling mechanism 200(1) and the coupling mechanism 200(2) may be disposed on the shroud 504. The coupling mechanism 200(1) and the coupling mechanism 200(2) may have a receptacle with interlocking jaws. A coupling mechanism of the case 102 and/or the case 400 may include a head that is insertable into the receptacle. The interlocking jaws may engage the head to retain the head within the interlocking jaws, or more generally, the receptacle. This engagement prevents a disengagement between the case 102 and/or the case 400 with the trolley 100.

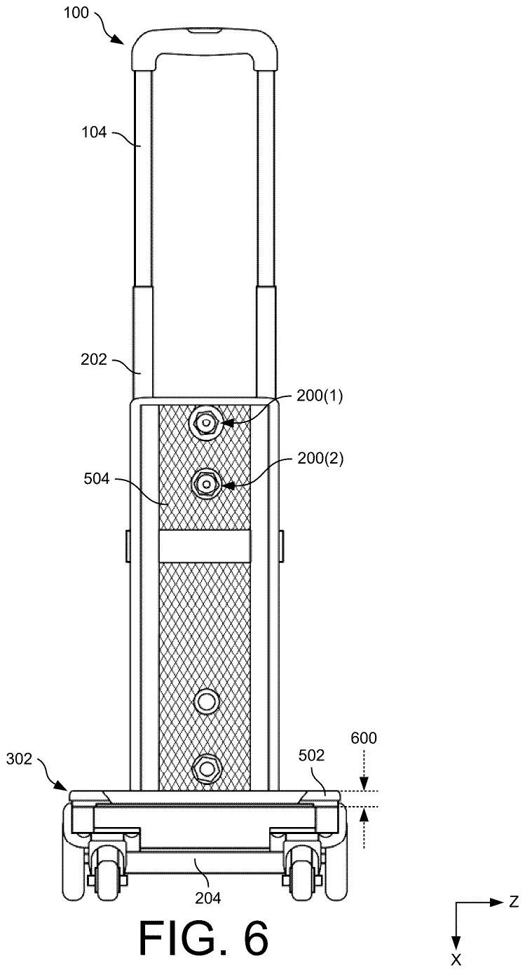

FIG. 6 illustrates a front view of the trolley 100, according to an embodiment of the present disclosure. The trolley 100 includes the handle 104, the frame 202, the base 204, the wheels 106, the shroud 504, the coupling mechanism 200(1), the coupling mechanism 200(2), and the channel 302. A top of the channel 302, which may be defined by a top of the first sidewall 500 or the second sidewall 502, may extend above the base 204 by a distance 600 and may be open to receive the flange 300, for example. The distance 600 may be such that the flange 300 of the case 102, for example, is disposed within the channel 302.

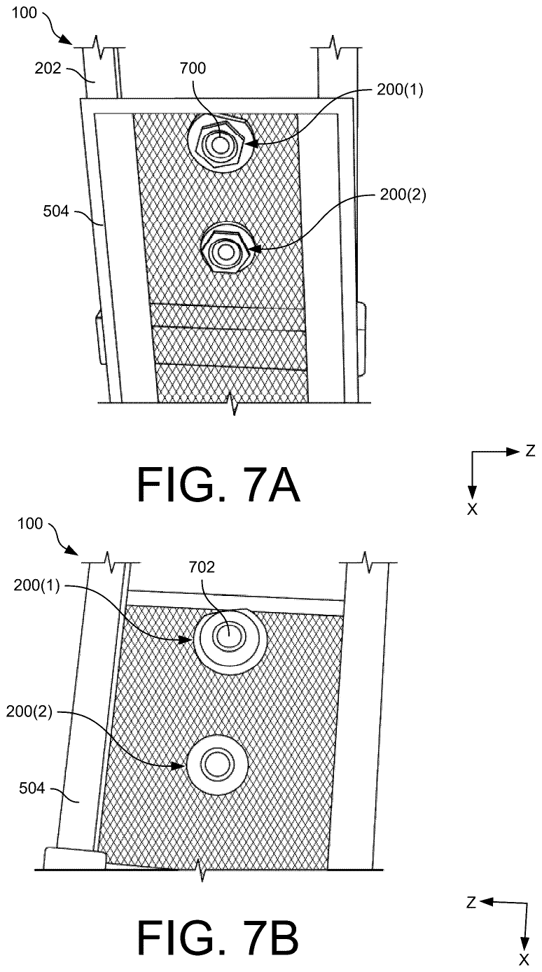

FIGS. 7A and 7B illustrate the coupling mechanism 200(1) and the coupling mechanism 200(2) of the trolley 100, according to an embodiment of the present disclosure. The view shown in FIG. 7A illustrates a front view of the coupling mechanism 200(1) and the coupling mechanism 200(2). The view shown in FIG. 7B illustrates a rear view of the coupling mechanism 200(1) and the coupling mechanism 200(2).

The coupling mechanisms 200 include a receptacle 700. As introduced above, and as will be explained herein, a coupling mechanism of the case 102 and/or the case 400 (e.g., head) may be insertable into the receptacle 700. The coupling mechanisms 200, within the receptacle 700, may include interlocking jaws that engage with the coupling mechanism of the case 102 and/or the case 400. For example, the coupling mechanism of the case 102 and/or the case 400 may be pushed into the receptacle 700 and engaged with the interlocking jaws. The interlocking jaws may release the coupling mechanism of the case 102 and/or the case 400 via actuation of a button 702 (e.g., push knob). For example, when the button 702 is depressed, the coupling mechanism of the case 102 and/or the case 400 may be pulled from within the receptacle 700. Each of the coupling mechanism 200(1) and the coupling mechanism 200(2) may have an associated button. Locating the button along a back of the trolley 100 permits the button 702 to be actuated to release the case 102 and/or the case 400.

Although described as coupling mechanisms 200, the coupling mechanisms 200 may represent, or alternatively be referred to interlocking mechanisms or features, locking mechanisms or features, etc. Moreover, although the coupling mechanisms 200 are described as having certain features, the coupling mechanisms 200 may represent any male/female connectors, tabs, slots, flanges, keys/keyways, etc., that engage with one another.

The coupling mechanisms 200 may be disposed along the shroud 504, which may be coupled to the frame 202 via fasteners, adhesives, welds, etc. Moreover, although a certain location of the coupling mechanisms 200 are shown, the coupling mechanisms 200 may be located differently than shown. Additionally, although two of the coupling mechanisms 200 are shown, the trolley 100 may include more than or less than two of the coupling mechanisms 200. In such instances, the trolley 100 may accommodate differently sized cases, or more than one of the coupling mechanisms 200 may be used to secure the case 102 and/or the case 400 to the trolley 100.

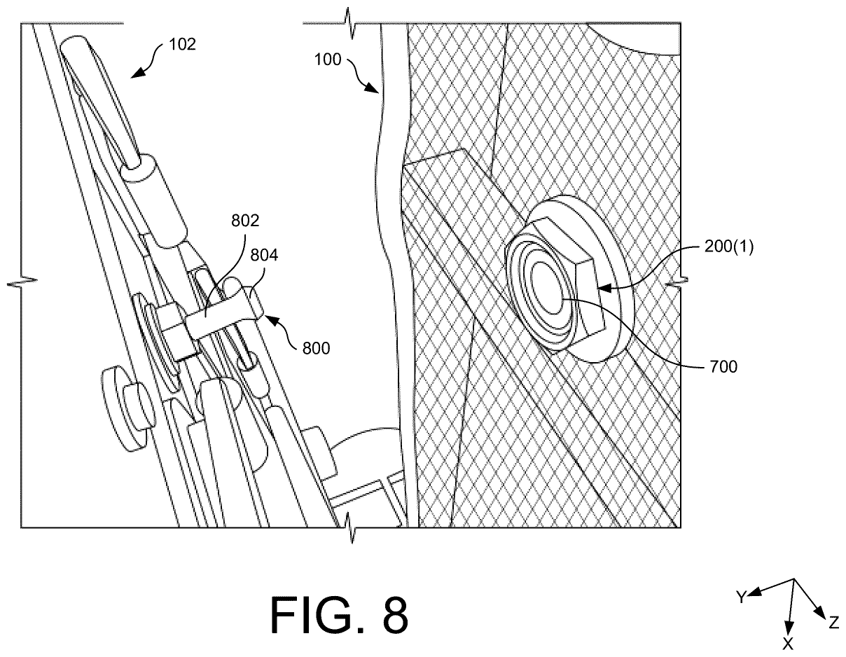

FIG. 8 illustrates an example coupling mechanism 800 of the case 102 that engages with the coupling mechanisms 200, according to an embodiment of the present disclosure. Although described in conjunction with the case 102, the case 400 may have a similar coupling mechanism for engaging with the coupling mechanisms 200.

The coupling mechanism 800 may be coupled to the case 102 (e.g., the housing 108). In an embodiment, the coupling mechanism 800 may be integrated with the case 102. The coupling mechanism 800 may include a shaft portion 802 and a head portion 804. The head portion 804 may be disposed on an end of the shaft portion 802. The head portion 804 may include a cross-sectional dimension that is larger than a cross-sectional dimension of the shaft portion 802.

The head portion 804 is sized to be insertable into the receptacle 700 of the coupling mechanism 200 (e.g., the coupling mechanism 200(1)). For example, the head portion 804 may be pushed into the receptacle 700 (e.g., in the Y-direction). When inserted into the receptacle 700, the interlocking jaws of the coupling mechanism 200(1) may engage around the head portion 804 to lock (or otherwise secure) the coupling mechanism 800 and the trolley 100 together. More particularly, the interlocking jaws may engage on a backside of the head portion 804, adjacent to the shaft portion 802, to prevent the head portion 804 being pulled past the interlocking jaws and out the receptacle 700. However, upon actuation (e.g., pressing) of the button 702, the interlocking jaws may disengage the head portion 804 and/or may retract to permit the head portion 804 to be pulled out the receptacle 700.

FIGS. 9A and 9B illustrates an engagement between the case 102 and the case 400, with the trolley 100, respectively, according to an embodiment of the present disclosure. In FIG. 9A, the case 102 is shown engaging with the trolley 100, while in FIG. 9B, the case 400 is shown engaging with the trolley 100.

The channel 302 is defined at least in part by the first sidewall 500 and the second sidewall 502. The first sidewall 500 and the second sidewall 502 are spaced apart from one another to permit the flange 300 of the case 102 to be disposed within the channel 302, or between the first sidewall 500 and the second sidewall 502. The flange 300, as discussed above, may be formed at least in part by the housing 108 and the lid 110. For example, the housing 108 may form a first portion of the flange 300 (or a first flange) and the lid 110 may form a second portion of the flange 300 (or a second flange). When disposed within the channel 302, the flange 300 may abut the first sidewall 500 and/or the second sidewall 502. In an embodiment, the first sidewall 500 and the second sidewall 502 may prevent reorientation or shifting of the case 102 in the Y-direction. This may help retain the flange 300 within the channel 302 or secure the case 102 to the trolley 100.

The case 400 may include a flange 900 that is defined at least in part by the housing 402 and the lid 404. As shown in FIG. 9B, however, the flange 900 may be located external to the channel 302. Instead, the flange 900 may abut the first sidewall 500 to prevent reorientation or shifting of the case 400 in the Y-direction.

Although a particular engagement between the case 102 and the trolley 100, or the case 400 and the trolley 100, is shown, other variations are envisioned. For example, the case 102 may engage with the base 204 via other attachment mechanisms, interlocking features, etc. As another example, rather than the flange 300 and/or the flange 900 being disposed within the channel 302, features of the trolley 100 may engage, snap onto, lock onto, etc., the flange 300 and/or the flange 900. In an embodiment, the case 102 and/or the case 400 may rest on the base 204.

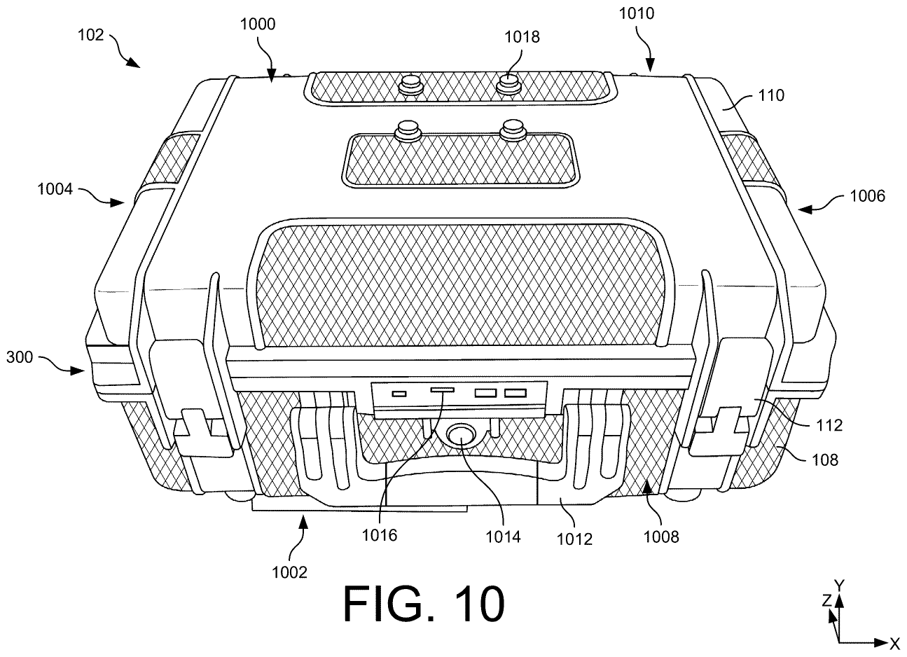

FIG. 10 illustrates an isometric view of the case 102, according to an embodiment of the present disclosure. The case 102 in FIG. 10 is shown in a closed state. In the closed state, the housing 108 and the lid 110 are coupled together via the latches 112. The latches 112 may extend from the housing 108 to engage with features (e.g., flanges, ribs, etc.) disposed on the lid 110. The latches 112 may knock over center to secure the housing 108 and the lid 110 together.

In an embodiment, the case 102 includes a top 1000, a bottom 1002 (e.g., spaced apart from the top 1000 in the Y-direction), a first side 1004, a second side 1006 (e.g., spaced apart from the first side 1004 in the X-direction), a front 1008, and a back 1010 (e.g., spaced apart from the front 1008 in the Z-direction). The flange 300 may extend around the first side 1004, the second side 1006, the front 1008, and the back 1010. Introduced above, the flange 300 is disposable within the channel 302 to secure the case 102 to the trolley 100.

The case 102 may include a handle 1012 disposed along the front 1008. The handle 1012 may hingedly couple to the housing 108. The front 1008 of the case 102 may also include a power switch 1014 (e.g., button, lever, etc.) that is depressed to power on and off computing components within the case 102, as will be discussed herein. The front 1008 of the case 102 may also include first ports 1016. Examples of the first ports 1016 may include audio jacks, USB-A connectors, USB-C connectors, Thunderbolt 4 connectors, etc.

As will be discussed herein, a display may be disposed within the case 102. In an embodiment, the display may be disposed within the lid 110. The display may be secured to the lid 110 via fasteners 1018, for example, that extend through a thickness of the case 102. For example, the fasteners 1018 may be disposed through the case 102, and therein, a nut may secure onto the fasteners 1018 for coupling the display to the case 102.

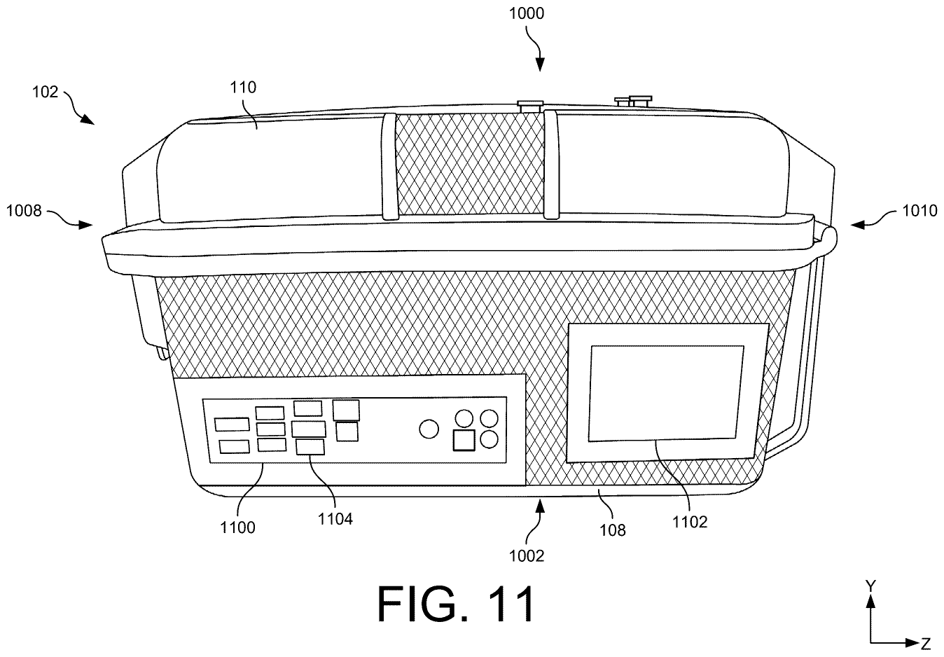

FIG. 11 illustrates a side view of the case 102 in the closed state, according to an embodiment of the present disclosure. The view shown in FIG. 11 illustrates the second side 1006 of the case 102.

The housing 108 may define a first aperture 1100 and a second aperture 1102 along the second side 1006. The first aperture 1100 may provide access to one or more second ports 1104. Examples of the second ports 1104 may include audio jacks, USB-A connectors, USB-C connectors, Thunderbolt 4 connectors, etc. Any number of the second ports 1104 may be included. The second aperture 1102 may represent an inlet for one or more fans disposed within the housing 108. Alternatively, the second aperture 1102 may represent an outlet for the one or more fans to exhaust air from within the housing 108. Regardless of the specific embodiment, air may either be drawn in or out of the second aperture 1102. Although not shown, a grill, guard, grate, etc., may be disposed over the second aperture 1102.

In an embodiment, the first aperture 1100 may be located more proximate to the front 1008 as compared to the second aperture 1102, and/or the second aperture 1102 may be located more proximate to the back 1010 as compared to the first aperture 1100. In addition, the first aperture 1100 may be located more proximate to the bottom 1002 as compared to the second aperture 1102. The first aperture 1100 and/or the second aperture 1102 may be similar in size and/or shape. Alternatively, the first aperture 1100 and/or the second aperture 1102 may be different in size and/or shape. The exact shape, layout, size and/or position of the first aperture 1100 and/or the second aperture 1102 may be based on the computing components disposed within the housing 108, and/or may accommodate the computing components disposed within the housing 108.

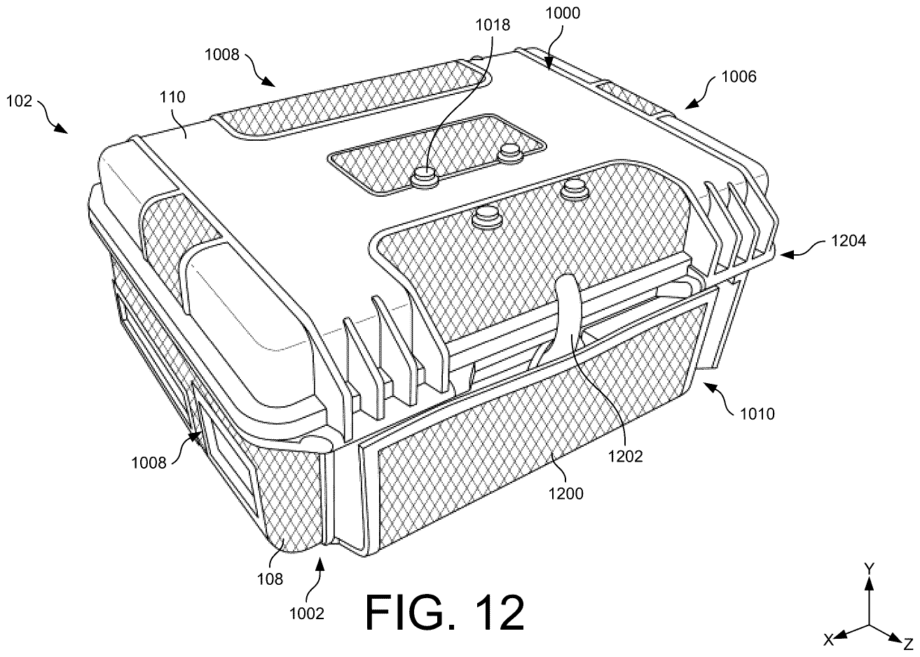

FIG. 12 illustrates a rear isometric view of the case 102 in the closed state, according to an embodiment of the present disclosure. A grill 1200 (e.g., grate, screen, etc.) may be disposed along the back 1010. The grill 1200 may be a wire mesh that protects one or more computing components within the housing 108. For example, removing the grill 1200 may expose a panel or aperture in the housing 108 that permits access to within an interior of the housing 108. The aperture may be used to place computing components within the case 102, and once installed, the grill 1200 may be installed to conceal the aperture. Moreover, the aperture may also accommodate airflow throughout the housing 108.

A conduit 1202 is shown routing between the housing 108 and the lid 110, at a location along the back 1010. Various cables, connectors, wires, etc., may be disposed within the conduit 1202. The cables disposed within the conduit 1202 may provide power to the display disposed within the lid 110, and/or may communicatively couple computing components disposed within the housing 108 to computing components disposed within the lid 110. The conduit 1202 may be flexible in nature to permit opening and closing of the lid 110.

The housing 108 and/or the lid 110 may include one or more gussets that provide structure to the case 102. As shown, the housing 108 and the lid 110 may be coupled to one another via one or more hinges 1204 disposed along the back 1010. The hinges 1204 may pivotably couple the housing 108 and the lid 110. The fasteners 1018 are further housing on the lid 110 for securing the display to the case 102.

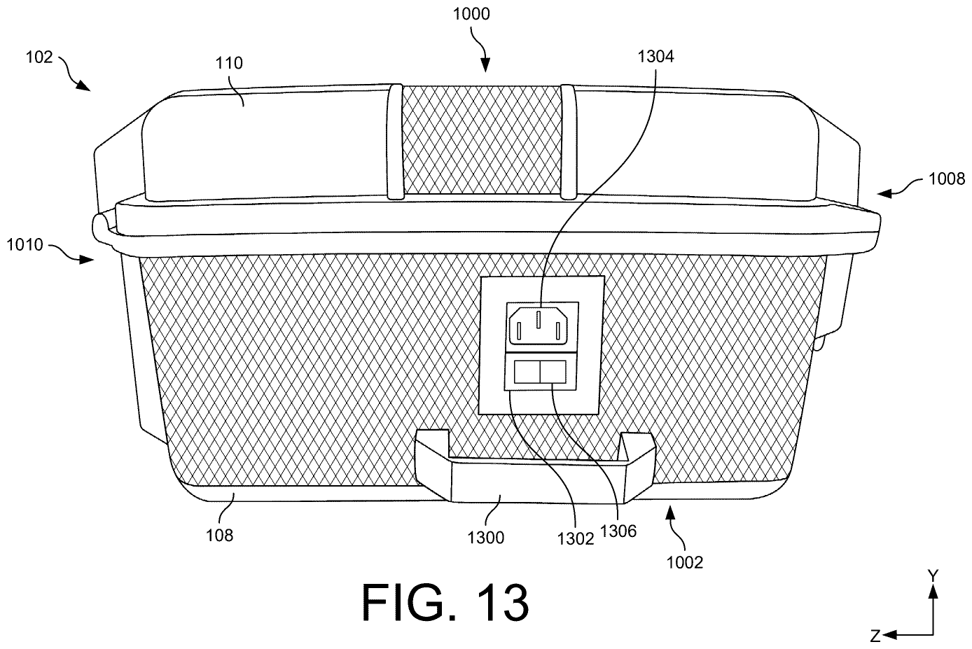

FIG. 13 illustrates a side view of the case 102 in the closed state, according to an embodiment of the present disclosure. The view shown in FIG. 13 illustrates the first side 1004 of the case 102.

The first side 1004 of the case 102 may include a handle 1300. In addition, the first side 1004 may include a third aperture 1302 that provides access to a power connector 1304 and/or a switch 1306. The location and/or the size of the third aperture 1302 may be based on the computing components disposed within the housing 108, and/or may accommodate the computing components disposed within the housing 108. In an embodiment, the third aperture 1302 may be located more proximate to the front 1008 of the case 102 as compared to the back 1010.

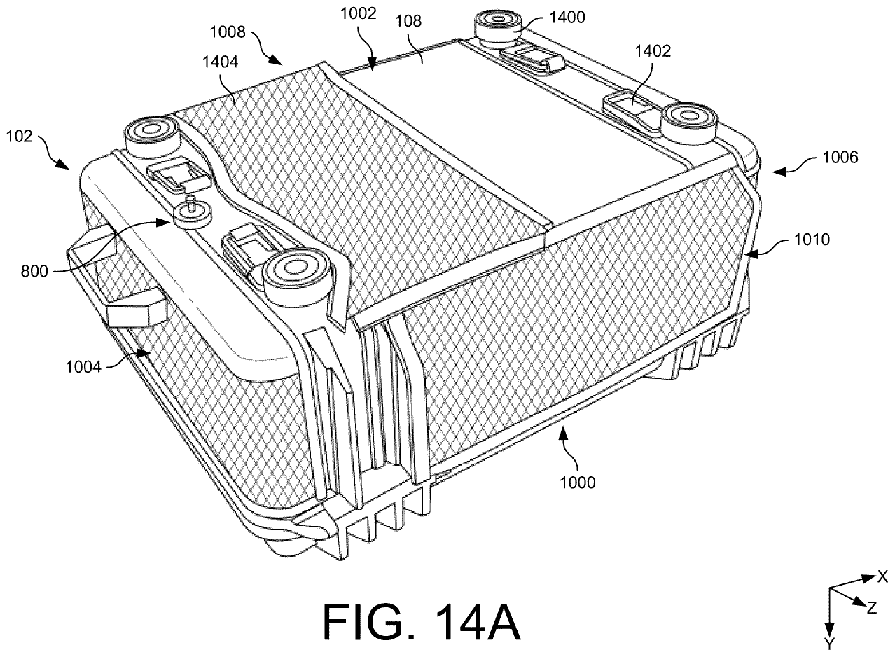

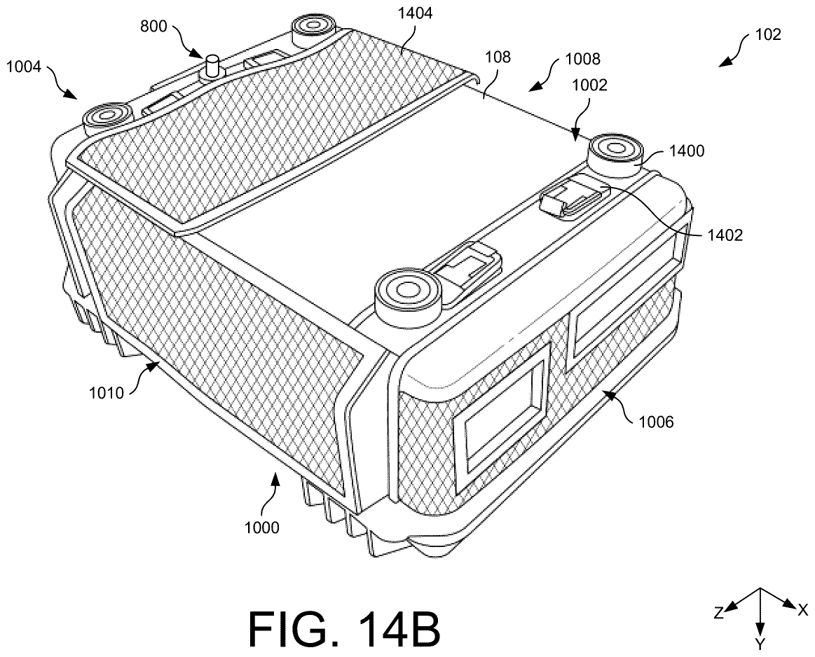

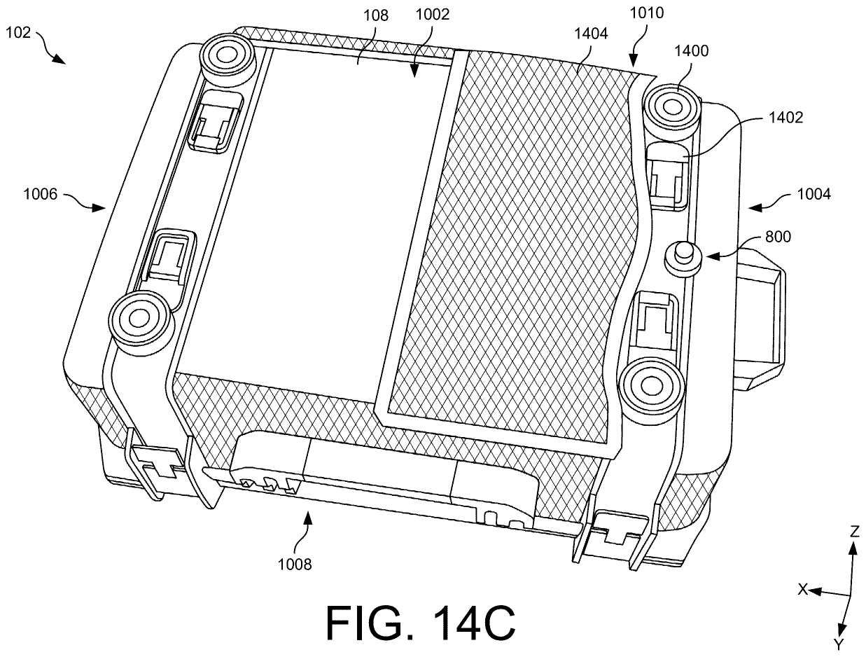

FIGS. 14A-14C illustrate isometric bottom views of the case 102 in the closed state, according to an embodiment of the present disclosure. The case 102 may include one or more standoffs 1400 disposed along the bottom 1002. In an embodiment, the standoffs 1400 may represent posts, pegs, pucks, etc., coupled to the housing 108. The standoffs 1400 may space the bottom 1002 of the case 102 apart from a surface on which the case 102 is disposed (e.g., desk, counter, shelf, etc.). As shown, the case 102 may include four of the standoffs 1400, where the standoffs 1400 may be disposed at corners of the housing 108.

The case 102 may also include one or more feet 1402. The feet 1402 are configured to move between an extended state and a collapsed state. In FIGS. 14A-14C, the feet are shown in the collapsed state, whereby the feet 1402 may lay substantially flat against the bottom 1002. The feet 1402, however, may deploy to the extended state, whereby the feet 1402 may serve to prop or orient the display relative to the user. In an embodiment, the feet 1402 may deploy to different heights, or distance, relative to the surface. For example, the feet 1402 posited adjacent to the back 1010 of the case 102 may extend by a first distance, while the feet 1402 positioned adjacent to the front 1008 of the case 102 may extend by a second distance that is less than the first distance. Accordingly, when the case transitions to the open state, the display may be tilted, or propped, towards the user.

The feet 1402 may also space the bottom 1002 of the case 102 apart from the surface to permit airflow to be drawn through a grill 1404 (e.g., grate, screen, etc.). The grill 1404 may protect fans disposed interior to the grill 1404, such as within the housing 108. The grill 1404 may be a wire mesh that protects one or more fans that are disposed beneath (e.g., in the Z-direction) the grill 1404. The grill 1404 may also include a foam filter or other medium to filter air and/or prevent debris from entering the case 102. Air may be drawn through the grill 1404 for cooling computing components disposed within the housing 108. The grill 1404 may be fastened to the case 102.

As shown, the grill 1404 may span a depth of the case 102, from the front 1008 to the back 1010. The grill 1404 may be disposed more proximate to the first side 1004 than the second side 1006. Edges of the grill 1404 may be wrapped with foam to prevent injury to the user and/or damage to components of the case 102.

In an embodiment, the standoffs 1400 may extend from the bottom 1002 by a distance that is greater than a height of the grill 1404. In doing so, when the case 102 rests on a surface (without the feet deployed), the case 102 may rest on the standoffs 1400 rather than the grill 1404. In addition, the coupling mechanism 800 may not contact the surface. For example, the case 102 may rest on the standoffs 1400 compared to the coupling mechanism 800 contacting the surface. In addition, the feet 1402 may be deployed to further space the case 102 from the surface.

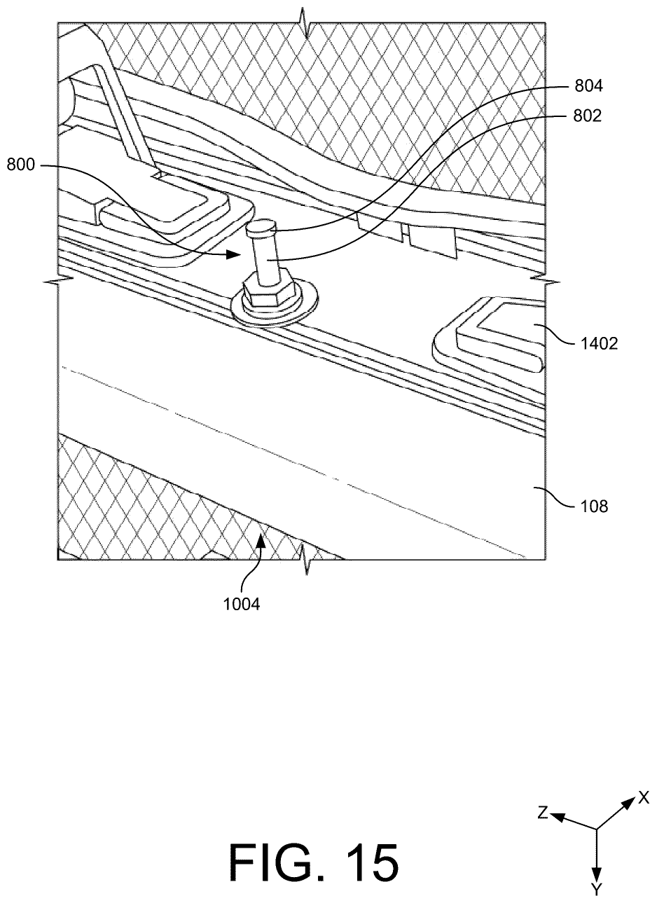

FIG. 15 illustrates an isometric view of the coupling mechanism 800, according to an embodiment of the present disclosure. Although discussed with regard to the case 102, the case 400 may include a coupling mechanism similar to the coupling mechanism 800.

As introduced above in FIG. 8, the coupling mechanism 800 may include the shaft portion 802 and the head portion 804. The shaft portion 802 extends from the bottom 1002 of the case 102. In an embodiment, the coupling mechanism 800 may be fastened to the bottom 1002 of the case 102 (e.g., via a fastener). The shaft portion 802 includes a cross-sectional dimension that is less than a cross-sectional dimension of the head portion 804. In doing so, when the head portion 804 is disposed within the receptacle 700, the head portion 804 may be retained within the receptacle 700 via the interlocking jaws. However, the button 702 may be actuated to release the coupling mechanism 800 via retracting the interlocking jaws and permitting the head portion 804 to be removed from within the receptacle 700 of the coupling mechanism 200.

In an embodiment, the coupling mechanism 800 may be disposed between the feet 1402. The coupling mechanism 800 may be located more proximate to the first side 1004 of the case 102 as compared to the second side 1006 of the case 102. Moreover, the coupling mechanism 800 may be centrally located between the front 1008 and the back 1010. Although the case 102 is described as including one of the coupling mechanisms 800, the case 102 may include more than one of the coupling mechanisms 800 for engaging with respective coupling mechanisms of coupling mechanism 200. In such instances, the coupling mechanisms 800 may be located at other locations about the case 102.

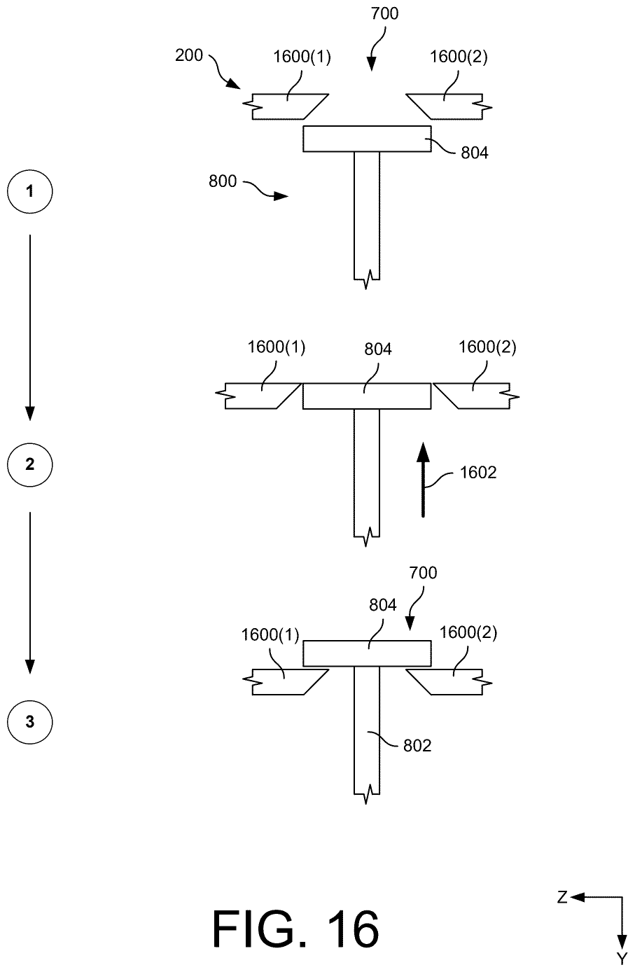

FIG. 16 illustrates an example sequence for securing the case 102 to the trolley 100 via an engagement between the coupling mechanism 200 and the coupling mechanism 800, according to an embodiment of the present disclosure.

At “1” in FIG. 16, the coupling mechanism 200 (whether the coupling mechanism 200(1) or the coupling mechanism 200(2)) and the coupling mechanism 800 are shown being disengaged. For example, the head portion 804 may be disposed external to the receptacle 700. The coupling mechanism 200 includes interlocking jaws 1600, such as an interlocking jaw 1600(1) and an interlocking jaw 1600(2). The interlocking jaws 1600 may be biased (e.g., via a spring) in a direction towards one another.

At “2” in FIG. 16, the coupling mechanism 800 may be advanced in a direction 1602. As the coupling mechanism 800 advances in the direction 1602, the head portion 804 engages with a surface, edge, etc., of the interlocking jaws 1600. During this engagement, the interlocking jaws 1600 part from one another or move in a direction away from one another. In other words, the head portion 804 urges past the interlocking jaws 1600 and into the receptacle 700. The surface of the interlocking jaws 1600 may be tapered to permit movement of the head portion 804 along the surface.

At “3” in FIG. 16, the head portion 804 is disposed within the receptacle 700, behind the interlocking jaws 1600. At this position, the coupling mechanism 800 may be locked, or retained within, the receptacle. For example, if the coupling mechanism 800 is urged in a direction opposite the direction 1602, the head portion 804 may abut against rear surface of the interlocking jaws 1600. At this position, however, the interlocking jaws 1600 may retain their position and resist separation. When the button 702 is actuated, the interlocking jaws 1600 may part in a direction from one another, thereby allowing the head portion 804 to be pulled through the receptacle.

As also shown at “3” in FIG. 16, a distance disposed between the interlocking jaws 1600 (e.g., in the Z-direction) may be less than a cross-sectional dimension of the head portion 804. This retains the head portion 804 within the receptacle 700. A cross-sectional dimension of the shaft portion 802 may be less than the distance disposed between the interlocking jaws 1600.

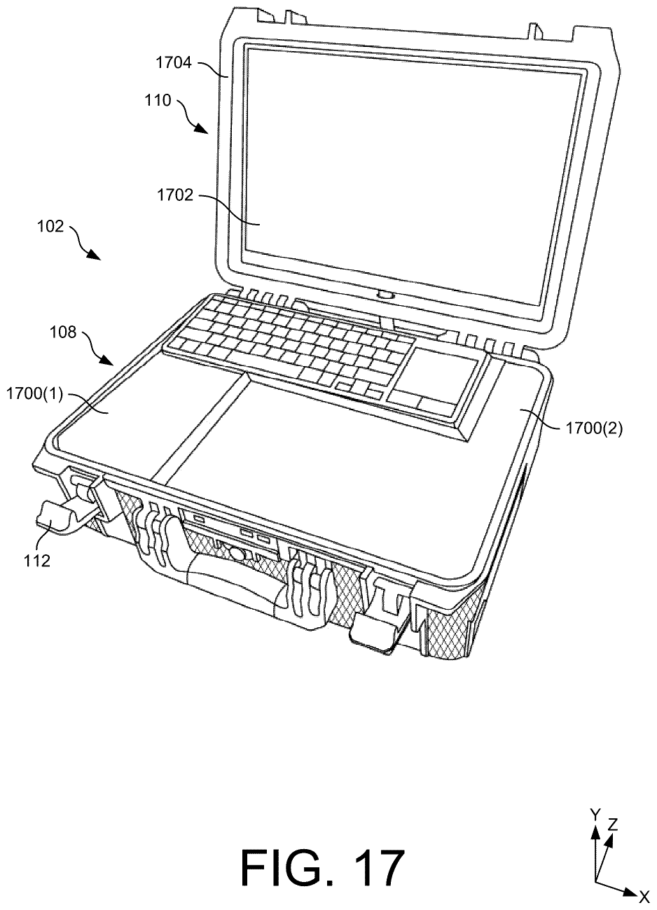

FIG. 17 illustrates a front isometric view of the case 102, showing the case 102 in an open state, according to an embodiment of the present disclosure. For example, from the closed state of the case 102, as previously shown herein, the lid 110 may be rotated about the hinges 1204. During this, the lid 110 transitions from the first position to the second position. Transitioning the lid 110 from the first position to the second position is also accomplished via the latches 112 disengaging with the lid 110.

The case 102 includes an interior cavity defined in part by the housing 108 and the lid 110. The interior cavity is inaccessible in the closed state of the case 102 but is accessible in the open state. As will be disposed herein, one or more first computing components may be disposed in a portion of the interior cavity defined by the housing 108 and one or more second computing components may be disposed in the lid 110. Details of the first computing components will be discussed herein. However, in an embodiment, the first computing components may include GPUs, power adapters, CPUs, motherboards, cooling components (e.g., fans), etc. The first computing components may be disposed beneath one or more covers 1700, such as a first cover 1700(1) and a second cover 1700(2). The first cover 1700(1) and/or the second cover 1700(2) may be transparent to permit viewing of the first computing components. Additionally, or alternatively, the first cover 1700(1) and/or the second cover 1700(2) may be perforated (e.g., include holes, mesh, etc.) to permit a flow of air.

The second computing components may include at least a display 1702. The display 1702 may be coupled to the lid 110 via the fasteners 1018. The display 1702 may be inset within the lid 110 so as to not extend beyond a rim 1704 of the lid 110. The conduit 1202 carries wires, cables, etc., that communicatively couple the first computing components and the second computing components.

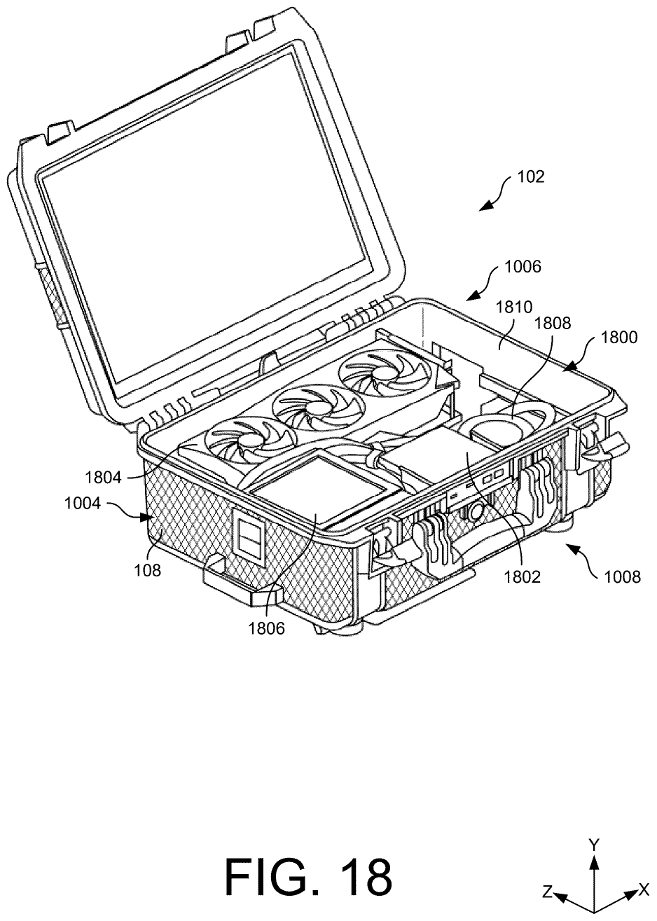

FIG. 18 illustrates a front isometric view of the case 102, showing the case 102 in an open state, according to an embodiment of the present disclosure. In FIG. 18, the covers 1700 are shown removed to illustrate first computing components residing within the housing 108.

The housing 108 may define an interior cavity 1800 in which the first computing components are disposed. As non-limiting examples, the first computing components may include a central processing unit (CPU) 1802, a GPU 1804, a power supply 1806, and a motherboard 1808. The CPU 1802, the GPU 1804, the power supply 1806, and the motherboard 1808 may be communicatively coupled to one another via cables, flex circuits, etc. The CPU 1802, the GPU 1804, and the motherboard 1808 may operate in unison with one another. In an embodiment, the motherboard 1808 may include the second ports 1104 that are accessible via the first aperture 1100 on the second side 1006.

The arrangement of the CPU 1802, the GPU 1804, the power supply 1806, and the motherboard 1808 permits the computing components to be compactly disposed within the interior cavity 1800. In an embodiment, the CPU 1802 may be disposed between the power supply 1806 and the motherboard 1808. The power supply 1806 may be located more proximate to the first side 1004 as compared to the CPU 1802 and the motherboard 1808, while the motherboard 1808 may be located more proximate to the second side 1006 as compared to the CPU 1802 and the power supply 1806. The CPU 1802, the power supply 1806, and the motherboard 1808 may also be located more proximate to the front 1008 as compared to the GPU 1804.

As shown, the GPU 1804 may include fans that provide cooling to the GPU 1804. The fans of the GPU 1804 may intake air through the bottom 1002 of the case 102 via the grill 1404 and/or the through the back 1010 of the case 102 via the grill 1200. The fans of the GPU 1804 may also intake air through the second aperture 1102 and/or the third aperture 1302.

Although certain computing components are shown and described, other computing components may be disposed within the interior cavity 1800. For example, adapters, hubs, etc., may be disposed within the interior cavity 1800. Moreover, the computing components may couple to the housing 108 via various brackets, mounts, etc. In an embodiment, the various brackets, mounts, etc., may be coupled to sidewalls 1810 of the case 102 via fasteners, adhesives, etc.

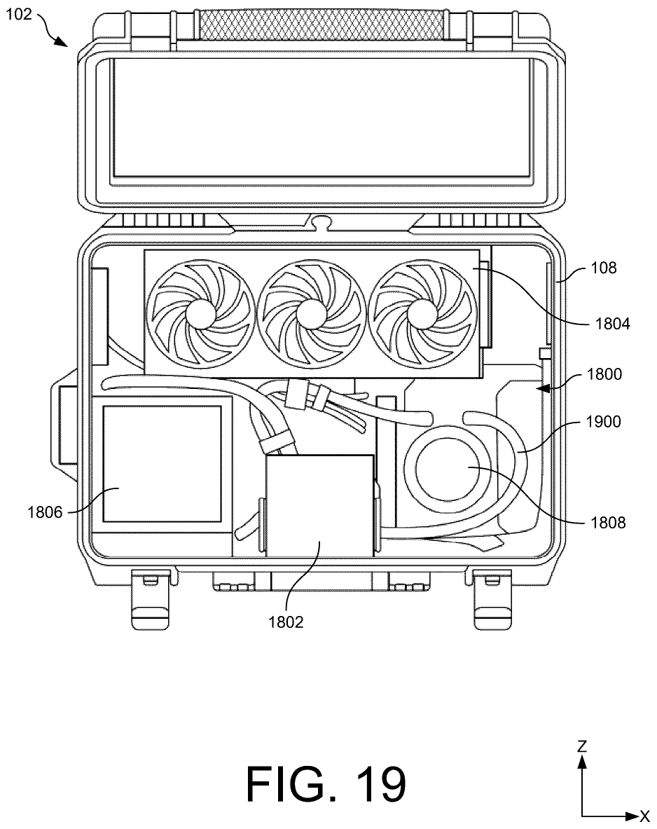

FIG. 19 illustrates a top view of the case 102, according to an embodiment of the present disclosure. As introduced above, the CPU 1802, the power supply 1806, the GPU 1804, and the motherboard 1808 may be disposed within the housing 108. Various cables 1900, for example, may be disposed between the CPU 1802, the power supply 1806, the GPU 1804, and the motherboard 1808, as well as other computing components within the case 102 for transferring power, signals, data, etc. In an embodiment, the CPU 1802 may include, or communicatively coupled to, the first ports 1016 and/or the power switch 1014.

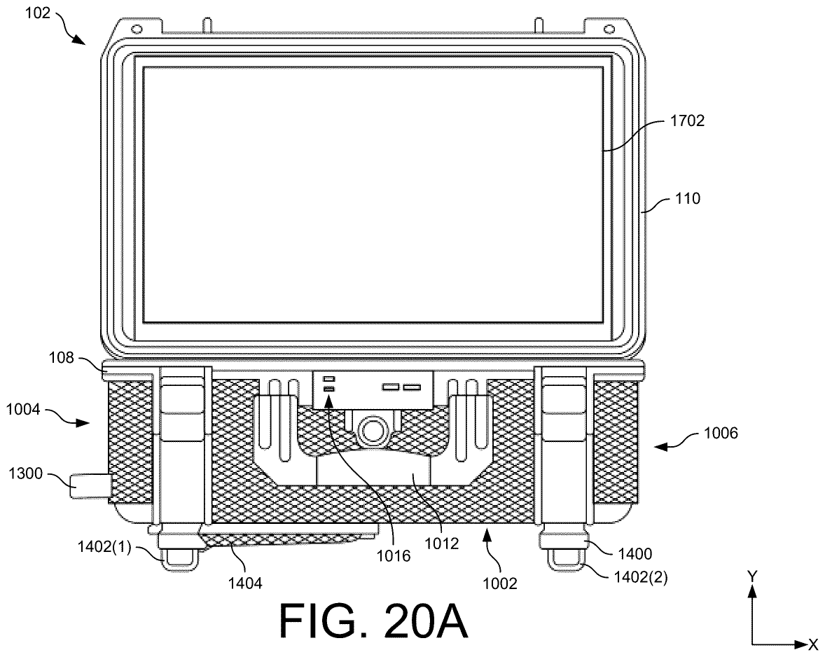

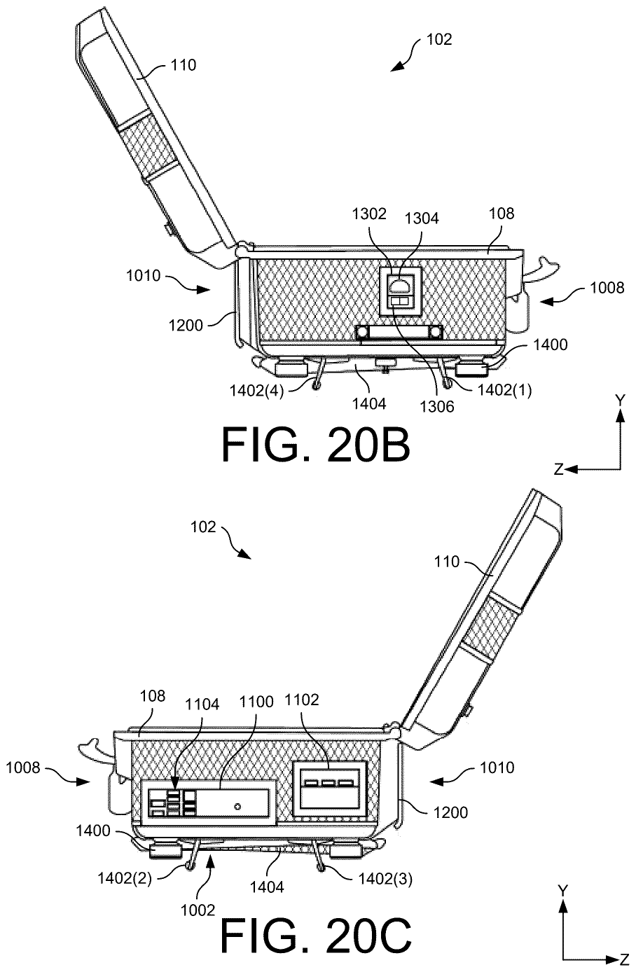

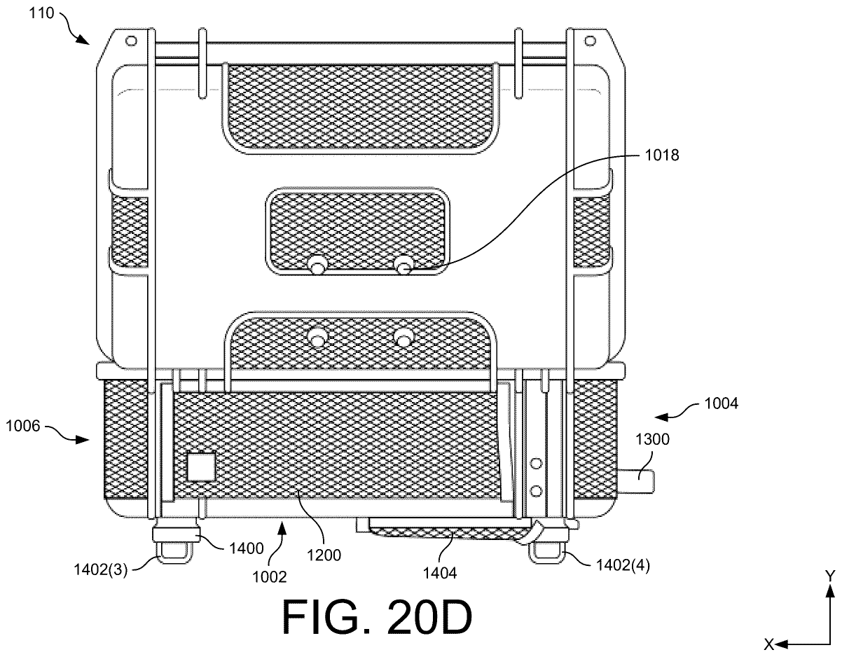

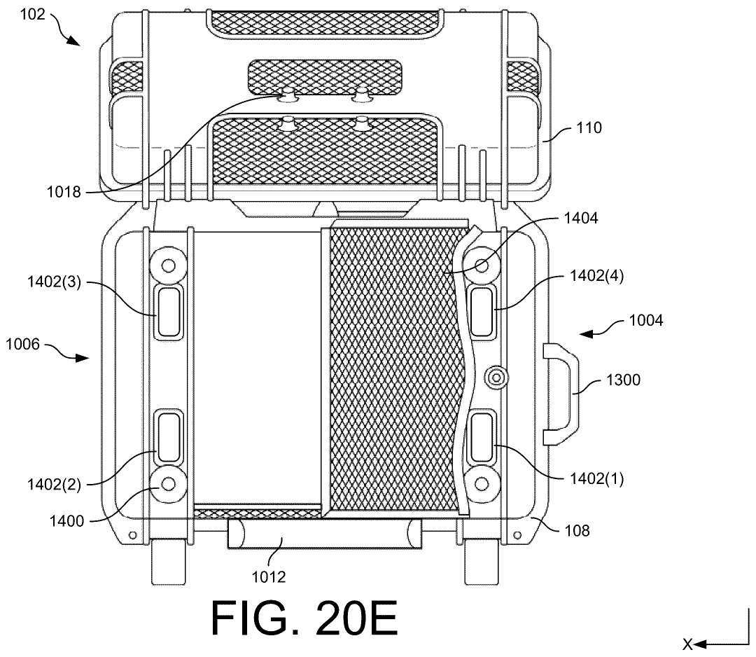

FIGS. 20A-20E illustrates various side views of the case 102 in the open state, according to an embodiment of the present disclosure. FIG. 20A illustrates a planar view of the front 1008, FIG. 20B illustrates a planar view of the first side 1004, FIG. 20C illustrates a planar view of the second side 1006, FIG. 20D illustrates a planar view of the back 1010, and FIG. 20E illustrates a planar view of the bottom 1002.

In FIGS. 20A-20E, the feet 1402 are shown in the extended state, whereby the feet 1402 may prop the bottom 1002 of the case 102 apart from a surface. For example, from their retracted state, the feet 1402 may deploy (e.g., pop outward, unfold, etc.) to the extended state. The feet 1402 may prop the case 102 by a distance greater than the standoffs 1400. Propping the bottom 1002 of the case 102 in this manner may increase an airflow into the case 102 to cool the computing components. Air may be drawn in through the bottom 1002, for example, via the power supply 1806, the fans on the GPU 1804, etc. The grill 1404 is shown disposed along the bottom 1002.

In an embodiment, the feet 1402 may prop the bottom 1002 by different amounts. For example, a first foot 1402(1) and a second foot 1402(2) located proximate to the front 1008, may prop the bottom 1002 apart from the surface by a first distance. A third foot 1402(3) and a fourth foot 1402(4) located proximate to the back 1010 may prop the bottom 1002 apart from the surface by a second distance that is greater than the first distance. In doing so, the case 102 may be tilted or oriented forward. This may increase a comfort of the user, for example, when viewing the display 1702.

The first ports 1016 are shown located along the front 1008, the second ports 1104 are shown located along the second side 1006, and the power connector 1304 and the switch 1306 may be located along the first side 1004. The first aperture 1100 provides access to the second ports 1104 and the third aperture 1302 provides access to the power connector 1304 and/or the switch 1306. Moreover, the second aperture 1102 may provide access to the interior cavity 1800. In an embodiment, a fan may be disposed adjacent to the second aperture 1102, ports may be disposed within the second aperture 1102, etc.

The grill 1200 is disposed along the back 1010 and the grill 1404 is disposed along the bottom 1002. The handle 1012 is disposed along the front 1008, and the handle 1300 is disposed along the first side 1004. The display 1702 is disposed within the lid 110 and couples to the lid 110 via the fasteners 1018.

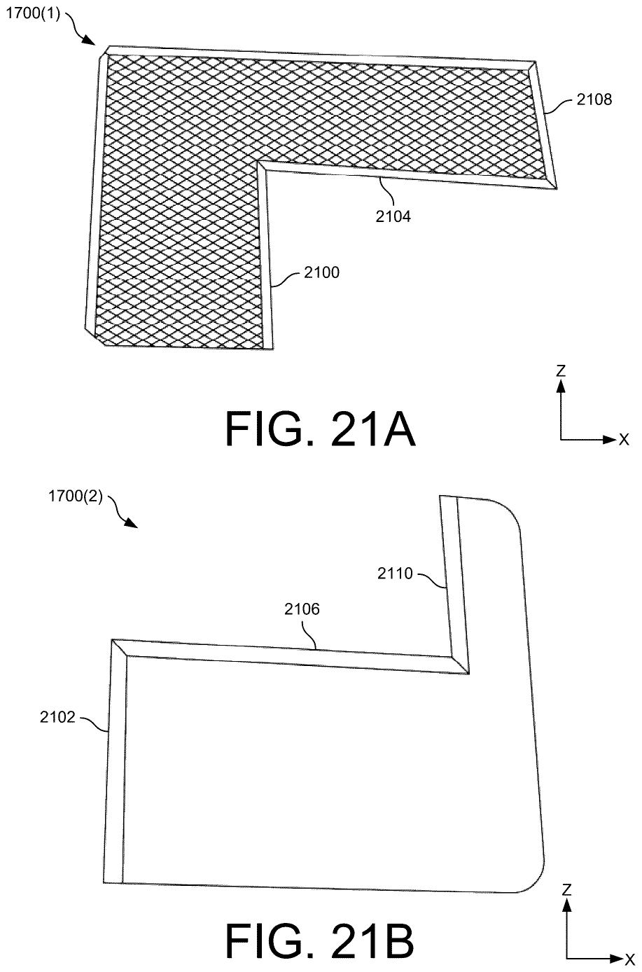

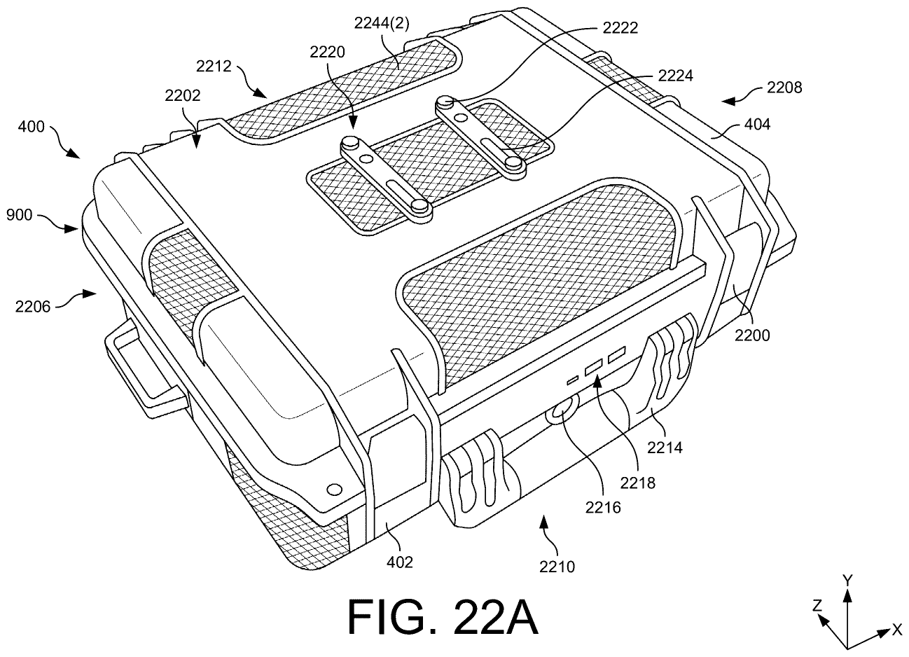

FIGS. 21A and 21B illustrate the covers 1700, according to an embodiment of the present disclosure. The first cover 1700(1) and the second cover 1700(2) may be disposed over the first computing components within the housing 108. In an embodiment, the first cover 1700(1) may be disposed over the power supply 1806 and the GPU 1804, as well as the fans of the GPU 1804. The second cover 1700(2) may be disposed over the CPU 1802 and the motherboard 1808.

The first cover 1700(1) may rest on a shelf, flange, gussets, etc., within the interior cavity 1800. In an embodiment, the covers 1700 may be manufactured from plastic, metal mesh, plexiglass, etc. In an embodiment, the first cover 1700(1) may permit air to flow therethrough to dissipate heat generated by the first computing components. In an embodiment, the second cover 1700(2) may be at least partially transparent to allow the user to view the first computing components.

The first cover 1700(1) and the second cover 1700(2) may fit together within the housing 108. For example, a first edge 2100 of the first cover 1700(1) may be disposed along a first edge 2102 of the second cover 1700(2), a second edge 2104 of the first cover 1700(1) may be disposed along a second edge 2106 of the second cover 1700(2). A third edge 2108 of the first cover 1700(1) may be disposed along a third edge 2110 of the second cover.

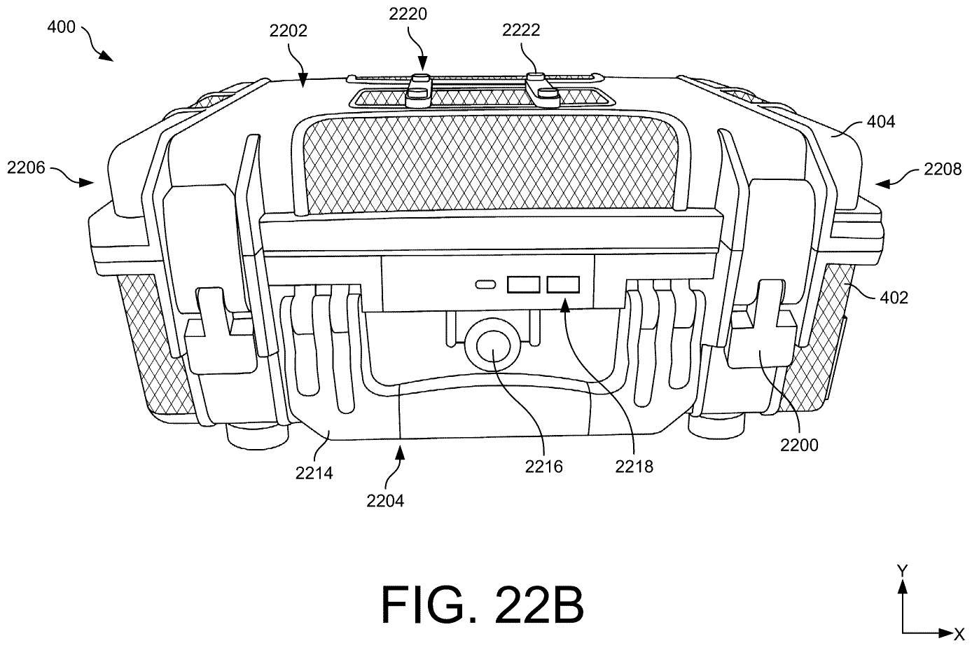

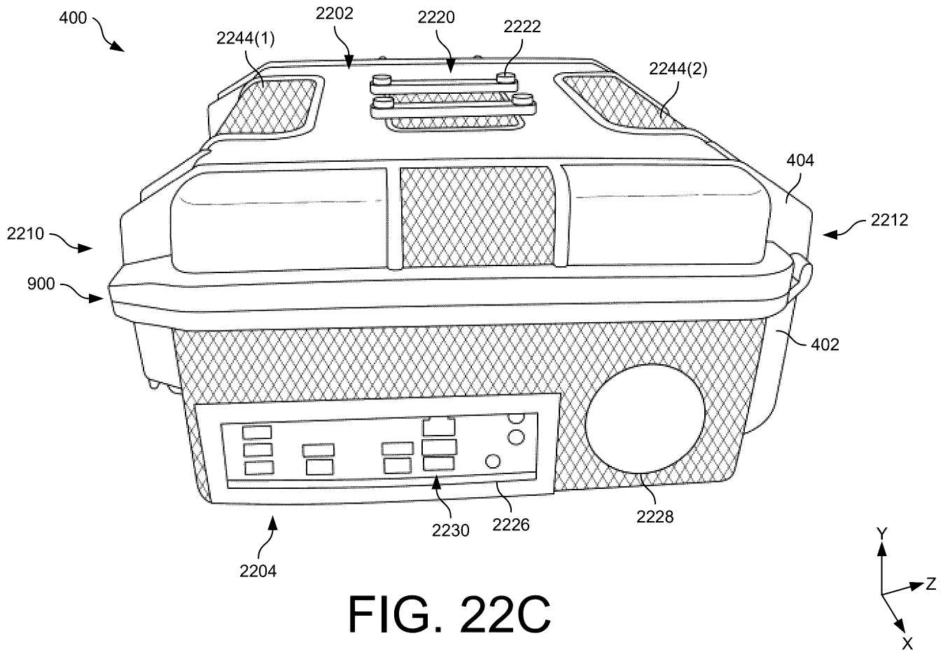

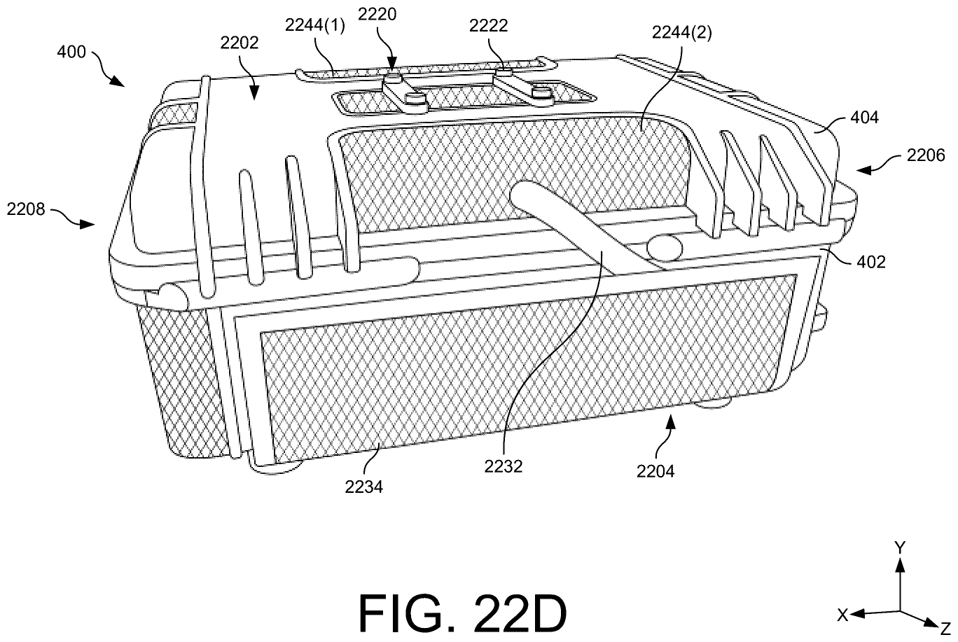

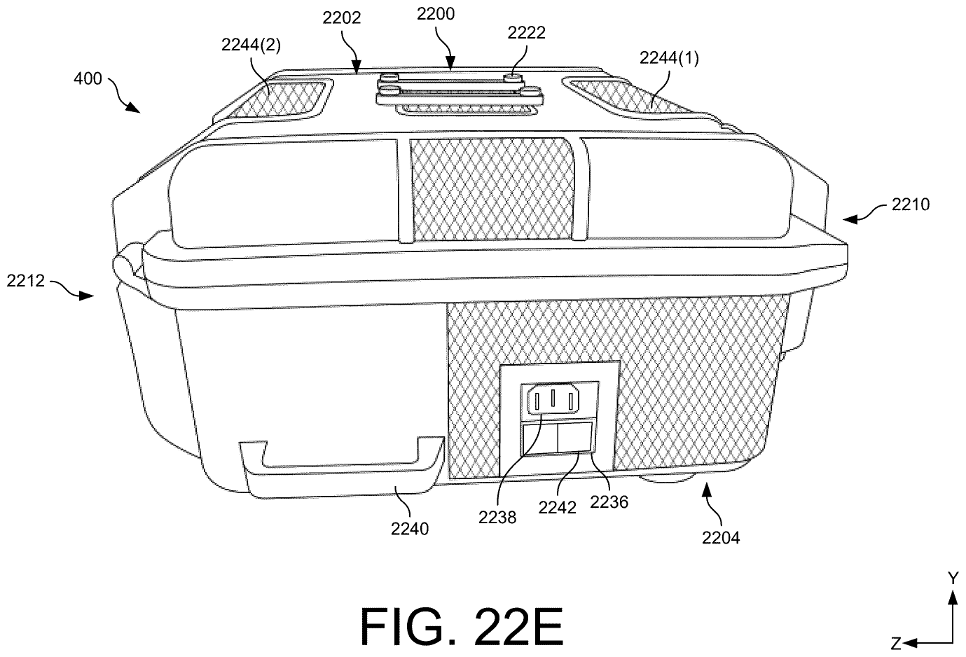

FIGS. 22A-22E illustrate various isometric views of the case 400, according to an embodiment of the present disclosure. FIG. 22A illustrates a front isometric view of the case 400, FIG. 22B illustrates a front view of the case 400, FIG. 22C illustrates a side of the case 400, FIG. 22D illustrates a rear isometric view of the case 400, and FIG. 22E illustrates a side of the case 400. The case 400 in FIGS. 22A-22E is shown in a closed state. In the closed state, the housing 402 and the lid 404 are coupled together via latches 2200. The latches 2200 may extend from the housing 402 to engage with features (e.g., flanged, ribs, etc.) disposed on the lid 404. The latches 2200 may knock over center to secure the housing 402 and the lid 404 together.

In an embodiment, the case 400 includes a top 2202, a bottom 2204 (e.g., spaced apart from the top 2202 in the Y-direction), a first side 2206, a second side 2208 (e.g., spaced apart from the first side 2206 in the X-direction), a front 2210, and a back 2212 (e.g., spaced apart from the front 2210 in the Z-direction). The flange 900 may extend around the first side 2206, the second side 2208, the front 2210, and the back 2212. Introduced above, the flange 900 is disposable adjacent to the channel 302, or the first sidewall 500, to secure the case 400 to the trolley 100.

The case 400 may include a handle 2214 disposed along the front 2210. The handle 2214 may hingedly couple to the housing 402. The front 2210 of the case 400 may also include a power switch 2216 (e.g., button, lever, etc.) that is depressed to power on and off computing components within the case 400, as will be discussed herein. The front 2210 of the case 400 may also include first ports 2218. Examples of the first ports 2218 may include audio jacks, USB connectors, USB-C connectors, etc.

As will be discussed herein, a display may be disposed within the case 400. In an embodiment, the display may be disposed within the lid 404. The display may be secured to the lid 404 via a bracket 2220. For example, a first portion of the bracket 2220 may secure to the display and a second portion of the bracket 2220 may secure to the lid 404. The bracket 2220 may permit adjustment of the display, for example, by allowing the display to slide, reorient, tilt, etc. In addition, the bracket 2220 may permit the display to be easily interchanged with other displays. The bracket 2220 may be secured to the case 400 via fasteners 2222. Some of the fasteners 2222 may translate within channels 2224 of the bracket 2220 to permit the display to reposition.

The housing 402 may define a first aperture 2226 and a second aperture 2228 along the second side 2208. The first aperture 2226 may provide access to one or more second ports 2230. Examples of the second ports 2230 may include audio jacks, USB connectors, USB-C connectors, Thunderbolt 4 connectors, etc. Any number of the second ports 2230 may be included. The second aperture 2228 may represent an inlet for one or more fans disposed within the housing 402. Alternatively, the second aperture 2228 may represent an outlet for the one or more fans to exhaust air from within the housing 402. Regardless of the specific embodiment, air may either be drawn in or out of the second aperture 2228. Although not shown, a grill, guard, grate, etc., may be disposed over the second aperture 2228.

In an embodiment, the first aperture 2226 may be located more proximate to the front 2210 as compared to the second aperture 2228, and/or the second aperture 2228 may be located more proximate to the back 2212 as compared to the first aperture 2226. In addition, the first aperture 2226 may be located more proximate to the bottom 2204 as compared to the second aperture 2228. The first aperture 2226 and/or the second aperture 2228 may be similar in size and/or shape. Alternatively, the first aperture 2226 and/or the second aperture 2228 may differ in size and/or shape. The exact shape, layout, size and/or position of the first aperture 2226 and/or the second aperture 2228 may be based on the computing components disposed within the housing 402, and/or may accommodate the computing components disposed within the housing 402.

A conduit 2232 is shown routing between the housing 402 and the lid 404, at a location along the back 2212. Various cables, connectors, wires, etc., may be disposed within the conduit 2232. The cables disposed within the conduit 2232 may provide power to the display disposed within the lid 404, and/or may communicatively couple computing components disposed within the housing 402 to computing components disposed within the lid 404. The conduit 2232 may be flexible in nature to permit opening and closing of the lid 404.

A grill 2234 (e.g., grate, screen, etc.) may be disposed along the back 2212. The grill 2234 may be a wire mesh that protects one or more computing components within the housing 402. For example, removing the grill 2234 may expose a panel or aperture in the housing 402 that permits access to within an interior of the housing 402. The aperture may be used to install computing components within the case 400, and once installed, the grill 2234 may be installed to conceal the aperture.

The first side 2206 of the case 400 may include a handle 2240. In addition, the first side 2206 may include a third aperture 2236 that provides access to a power connector 2238 and/or a switch 2242. The location and/or the size of the third aperture 2236 may be based on the computing components disposed within the housing 402, and/or may accommodate the computing components disposed within the housing 402. In an embodiment, the third aperture 2236 may be located more proximate to the front 2210 of the case 400 as compared to the back 2212.

One or more grills 2244 may be coupled to the lid 404. The grills 2244 may be disposed over holes in the lid 404 that permit airflow throughout the case 400 and/or to prevent overheating of the computing components. In some instances, the grills 2244 may include a grill 2244(1) disposed along the front 2210 and a grill 2244(2) disposed along the back 2212. The grills 2244 may be a meshed metal that couples to the lid 404.

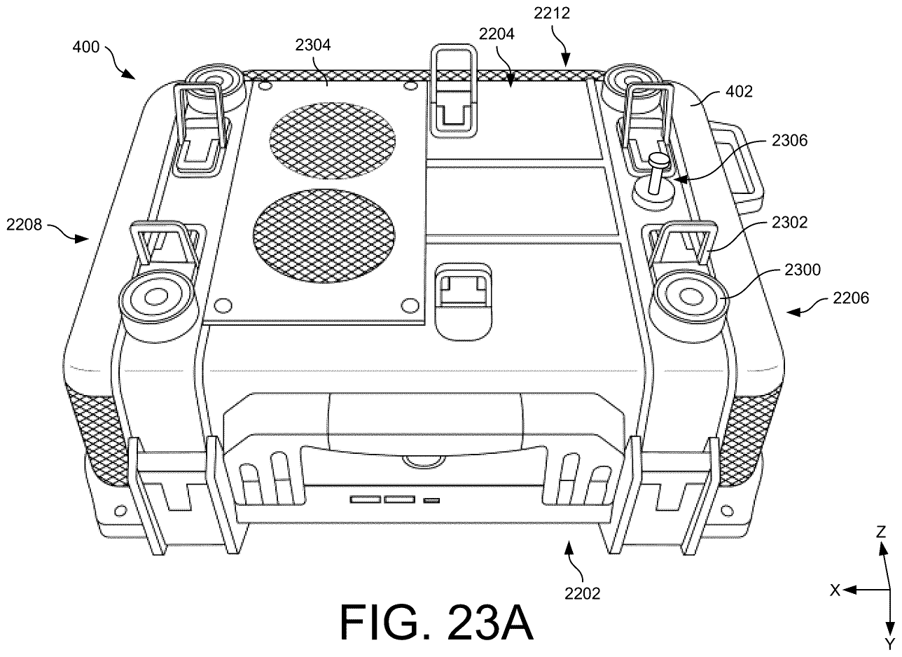

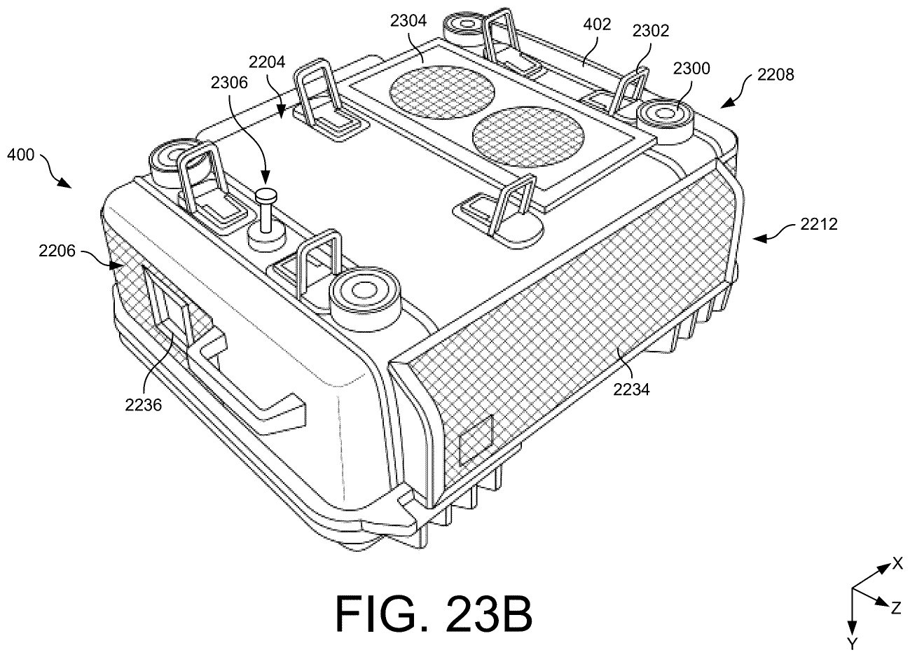

FIGS. 23A and 23B illustrate bottom isometric views of the case 400, according to an embodiment of the present disclosure. The case 400 may include one or more standoffs 2300 disposed along the bottom 2204. In an embodiment, the standoffs 2300 may represent posts, pegs, pucks, etc. The standoffs 2300 may space the bottom 2204 of the case 400 apart from a surface on which the case 400 is disposed (e.g., desk, counter, shelf, etc.). As shown, the case 400 may include four of the standoffs 2300, where the standoffs 2300 may be disposed at corners of the case 400. However, more than or less than four of the standoffs 2300 may be included on the case 400.

The case 400 may also include one or more feet 2302. The feet 2302 are configured to move between an extended state and a collapsed state. In FIGS. 23A and 23B, the feet 2302 are shown in the extended state, whereby the feet 2302 serve to prop or orient the display relative to the user. In an embodiment, the feet 2302 may deploy to different heights, or distance, relative to the surface. As shown, the case 400 may include six of the feet 2302. However, more than or less than six of the feet 2302 may be included on the case 400.

The feet 2302 may also space the bottom 2204 of the case 400 apart from the surface to permit airflow to be drawn through a grill 2304 (e.g., grate, screen, etc.). The grill 2304 may protect fans disposed interior to the grill 2304, such as within the housing 402. The grill 2304 may be a wire mesh that protects one or more fans that are disposed beneath (e.g., in the Z-direction) the grill 2304. The grill 2304 may also include a foam filter or other medium to filter air and/or prevent debris from entering the case 400. Air may be drawn through the grill 2304 for providing cooling to computing components disposed within the housing 402.

The grill 2304 may span a depth of the case 400, from the front 2210 to the back 2212. The grill 2304 may be disposed more proximate to the second side 2208 compared to the first side 2206. Edges of the grill 2304 may be wrapped with foam to prevent injury to the user and/or damage to components of the case 400.

The case 400 may also include a coupling mechanism 2306, which may be similar to the coupling mechanism 800 and engage with the coupling mechanism 200 (e.g., the coupling mechanism 200(2)) for securing the case 400 to the trolley 100. The coupling mechanism 2306 may be disposed along the bottom 2204, more proximate to the first side 2206 than the second side 2208.

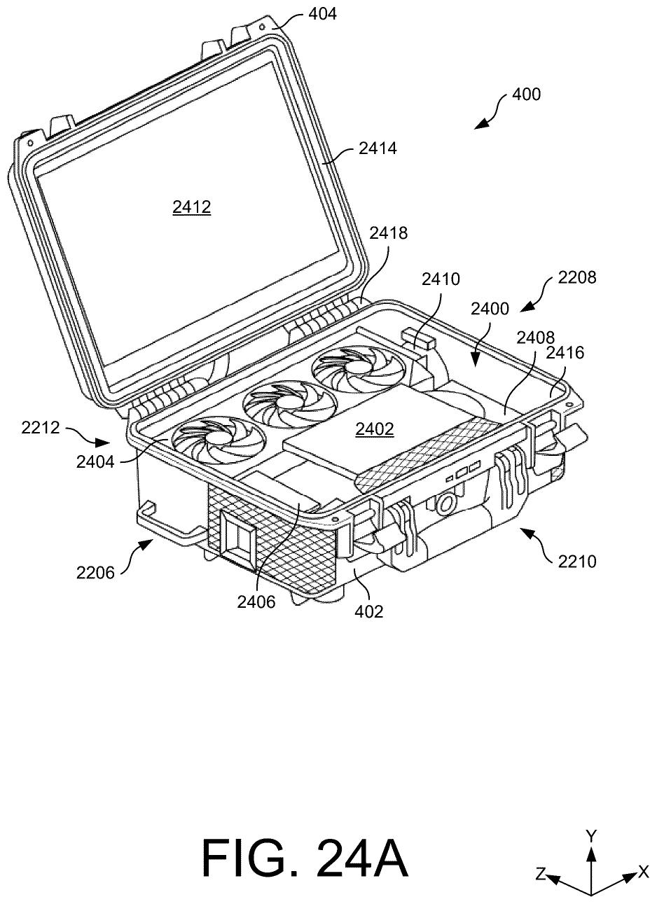

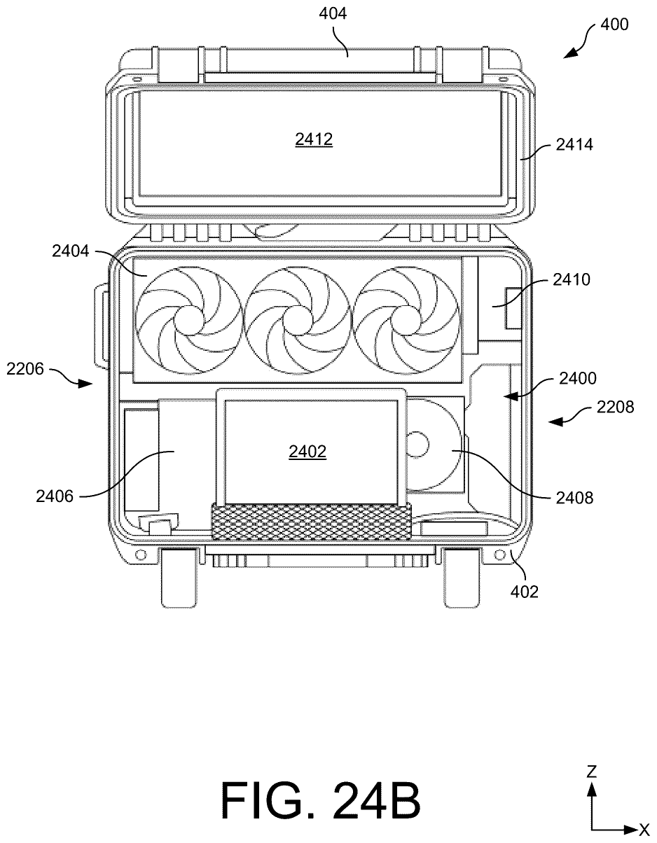

FIGS. 24A and 24B illustrate the case 400 in an open state, according to an embodiment of the present disclosure. From the closed state of the case 400, as previously shown herein, the lid 404 may be rotated about hinges 2418. During this, the lid 404 transitions from a first position to a second position. Transitioning the lid 404 from the first position to the second position is also accomplished via the latches 2200 disengaging with the lid 404.

The case 102 includes an interior cavity 2400, which is defined in part via the housing 402 and the lid 404. The interior cavity 2400 is inaccessible in the closed state of the case 400 but is accessible in the open state. One or more first computing components may be disposed in a portion of the interior cavity 2400 defined by the housing 402. As non-limiting examples, the first computing components may include a display 2402, a GPU 2404, a power supply 2406, a motherboard 2408, and a cooling fan 2410. The first computing components may also include a CPU disposed vertically beneath the display 2402. The display 2402, the GPU 2404, the power supply 2406, the motherboard 2408, the CPU, and the cooling fan 2410 may be communicatively coupled to one another via cables, flex circuits, etc. In an embodiment, the motherboard 2408 may include the second ports 2230 that are accessible via the first aperture 2226 on the second side 2208, and/or the CPU may include the first ports 2218. The cooling fan 2410 may be accessible via the second aperture 2228.

One or more second computing components may be disposed in the lid 404. The second computing components may include at least a display 2412. The display 2412 may be coupled to the lid 404 via the bracket 2220 and the fasteners 2222. The display 2412 may be inset within the lid 404 so as to not extend beyond a rim 2414 of the lid 404. The conduit 2232 carries wires, cables, etc., that communicatively couple the first computing components to the second computing components.

The arrangement of the display 2402, the GPU 2404, the power supply 2406, the motherboard 2408, the CPU, and the cooling fan 2410 permits the computing components to be compactly disposed within the interior cavity 2400. In an embodiment, the display 2402 may be disposed between the power supply 2406 and the motherboard 2408. The power supply 2406 may be located more proximate to the first side 2206 as compared to the display 2402 and the motherboard 2408, while the motherboard 2408 may be located more proximate to the second side 2208 as compared to the display 2402 and the power supply 2406. The display 2402, the power supply 2406, and the motherboard 2408 may also be located more proximate to the front 2210 as compared to the GPU 2404 and the cooling fan 2410.

As shown, the GPU 2404 may include fans that provide cooling to the GPU 2404. The fans of the GPU 2404 may intake air through the bottom 2204 of the case 400. The fans of the GPU 2404 may also intake air through the grill 2304.

Although certain computing components are shown and described, other computing components may be disposed within the interior cavity 2400. Moreover, the computing components may couple to the housing 402 via various brackets, mounts, etc. In an embodiment, the various brackets, mounts, etc., may be coupled to sidewalls 2416 of the case 400 via fasteners, adhesives, etc. Various cables, for example, may be disposed between the computing components for transferring power, signals, data, etc.

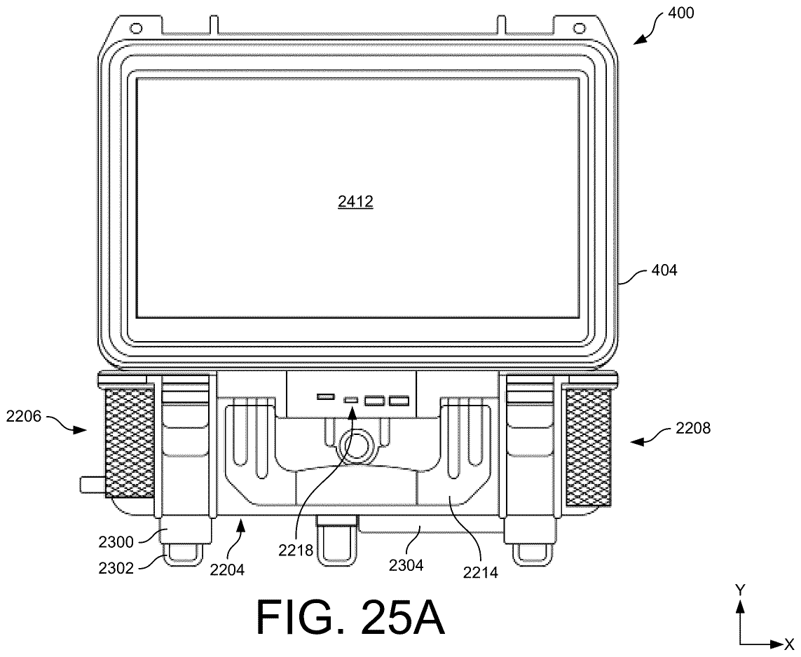

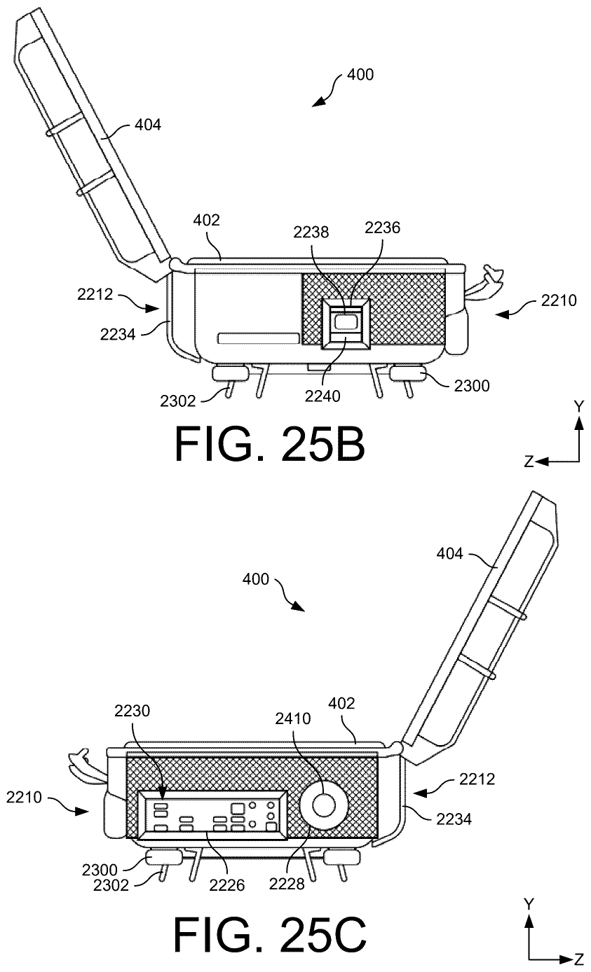

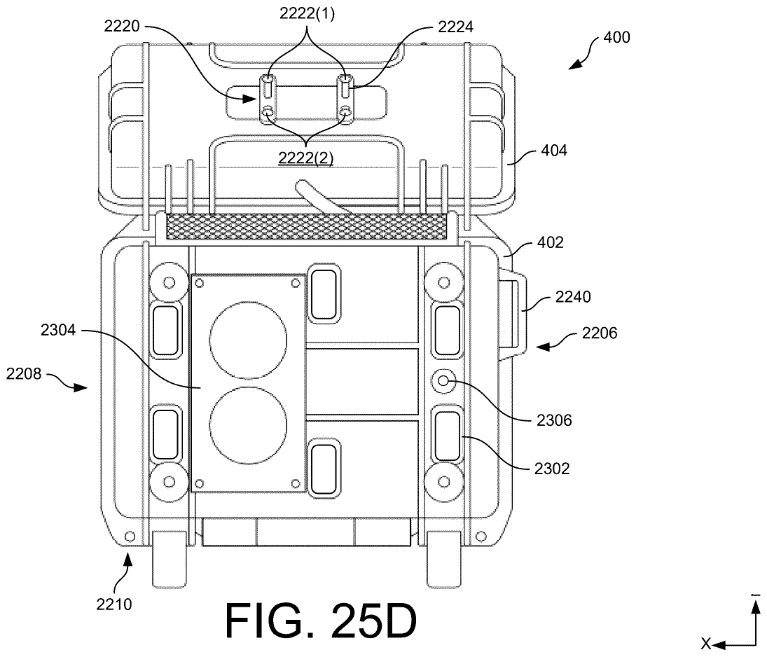

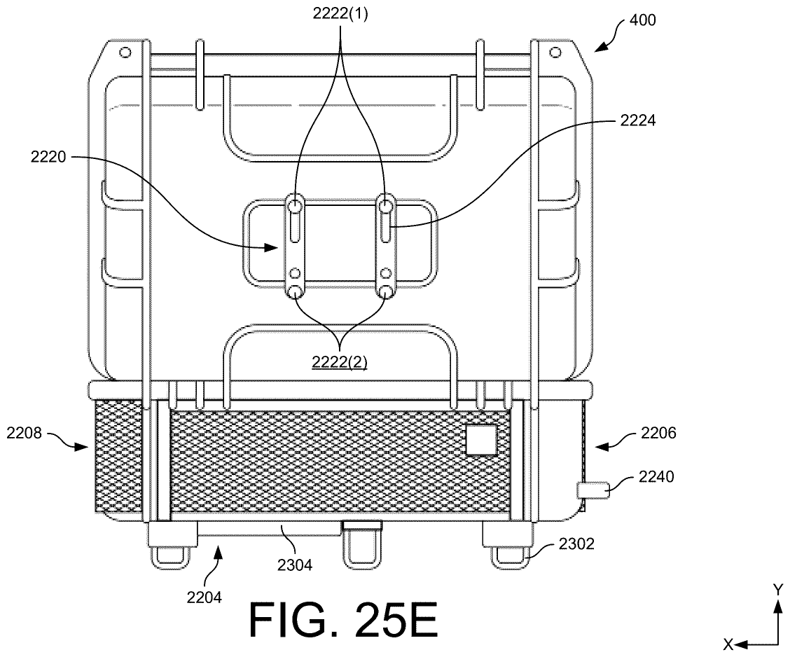

FIGS. 25A-25E illustrates various side views of the case 400 in the open state, according to an embodiment of the present disclosure. FIG. 25A illustrates a planar view of the front 2210, FIG. 25B illustrates a planar view of the first side 2206, FIG. 25C illustrates a planar view of the second side 2208, FIG. 25D illustrates a planar view of the bottom 2204, and FIG. 25E illustrates a planar view of the back 2212.

In FIGS. 25A-25E, the feet 2302 are shown in the extended state, whereby the feet 2302 may prop the bottom 2204 of the case 400 apart from a surface. Propping the bottom 2204 of the case 400 in this manner may increase an airflow into the case 400 to cool the computing components. Air may be drawn in through the bottom 2204, for example, via the power supply 2406, the fans on the GPU 2404, etc. The grill 2304 is shown disposed along the bottom 2204.

The first ports 2218 are shown located along the front 2210, the second ports 2230 are shown located along the second side 2208, the cooling fan 2410 is shown located along the second side 2208 and the power connector 2238 and the switch 2242 may be located along the first side 2206. The first aperture 2226 provides access to the second ports 2230, the second aperture 2228 provides access to the cooling fan 2410, and the third aperture 2236 provides access to the power connector 2238 and/or the switch 2242.

The grill 2234 is disposed along the back 2212. The handle 2214 is disposed along the front 2210, and the handle 2240 is disposed along the first side 2206. The display 2412 is disposed within the lid 404 and couples to the lid 404 via the bracket 2220 and the fasteners 2222. The bracket 2220 includes the channels 2224 to reposition the display 2412. For example, first fasteners 2222(1) may be loosened and translated within the channels 2224 of the bracket 2220, respectively. Once at a desired position, the first fasteners 2222(1) may be tightened. Second fasteners 2222(2) may remain tightened to keep the bracket 2220 coupled to the lid 404.

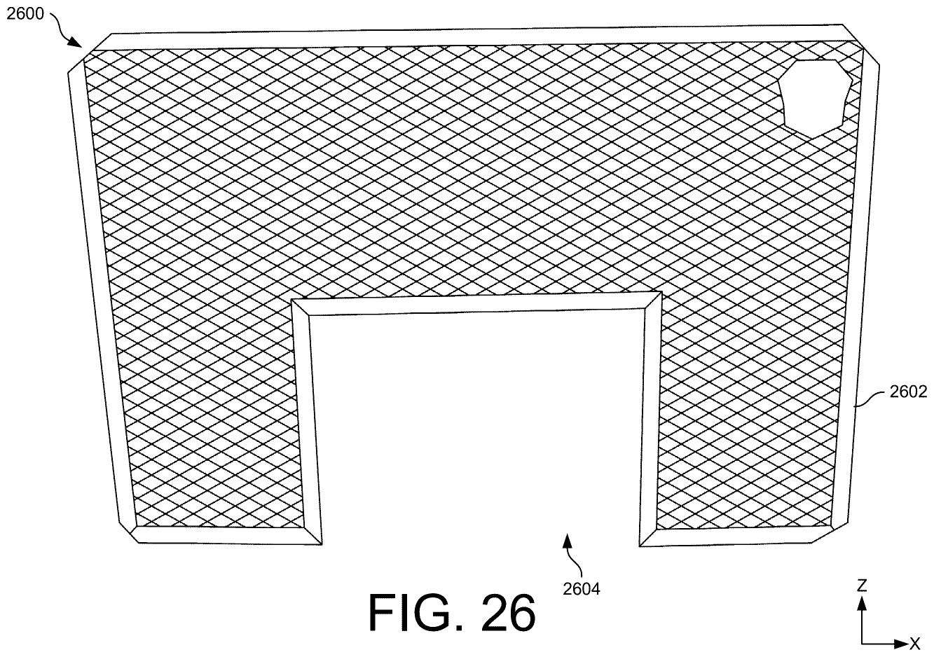

FIG. 26 illustrates an example cover 2600 of the case 400, according to an embodiment of the present disclosure. The first computing components of the case 400 may be disposed beneath the cover 2600. The cover 2600 may be perforated (e.g., include holes, mesh, etc.) to permit air flow throughout the case 400. A perimeter 2602 of the cover 2600 may rest or be disposed on flanges on the sidewalls 2416 of the case 400. A cutout 2604 (e.g., notch, indent, etc.) may provide a space for the display 2402.

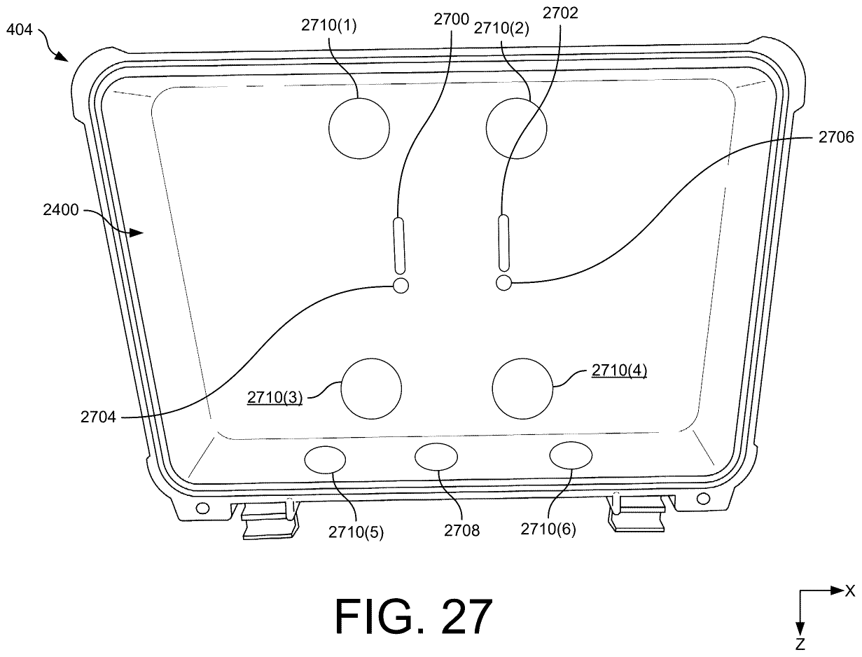

FIG. 27 illustrates the lid 404, showing the display 2412 removed, according to an embodiment of the present disclosure. The lid 404 defines a portion of the interior cavity 2400 in which the display 2412 resides. For example, the lid 404 may include a depth (e.g., in the Y-direction) to receive a thickness of the display 2412.

The lid 404 includes channels and apertures for accommodating the bracket 2220 and the fasteners 2222. For example, the first fasteners 2222(1) may be configured to translate within a first channel 2700 and a second channel 2702, respectively. The second fasteners 2222(2) may be disposed through a first aperture 2704 and a second aperture 2706, respectively. The second fasteners 2222(2) may secure the bracket 2220 to the lid 404. The first fasteners 2222(1) may secure the display 2412 to the lid 404. An opening 2708 may accommodate the conduit 2232 routing between the housing 402 and the lid 404.

Holes 2710 may be disposed through the lid 404 for permitting airflow through the case 400. In some instances, the holes 2710 may be disposed through the top 2202, the front 2210, and/or the back 2212. The holes 2710 may be concealed on an exterior of the case 400 via the grills 2244. In some instances, the holes 2710 may include a hole 2710(1), a hole 2710(2), a hole 2710(3), a hole 2710(4), a hole 2710(5), and/or a hole 2710(6). The holes 2710 may be similar or different in size.

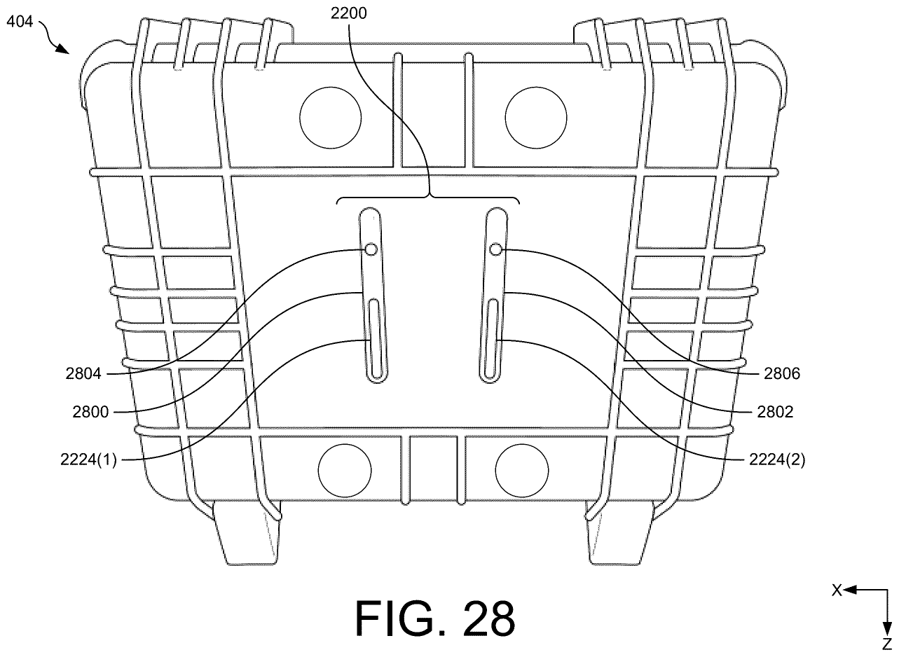

FIG. 28 illustrates details of the bracket 2220, according to an embodiment of the present disclosure. The bracket 2220 may include a first segment 2800 and a second segment 2802. The first segment 2800 and the second segment 2802 may be similar. The first segment 2800 may define a first aperture 2804 that aligns with the first aperture 2704. One of the second fasteners 2222(2) may be disposed through the first aperture 2804 and the first aperture 2704 to secure the first segment 2800 to the lid 404. Likewise, the second segment 2802 may define a second aperture 2806 that aligns with the second aperture 2706. One of the second fasteners 2222(2) may be disposed through the second aperture 2806 and the second aperture 2706 to secure the second segment 2802 to the lid 404.

The first segment 2800 may define the channel 2224(1) that aligns with the first channel 2700. The second segment 2802 may define the channel 2224(2) that aligns with the second channel 2702. The first fasteners 2222(1) may be translatable within the first channel 2700 and the channel 2224(1), and the second channel 2702 and the channel 2224(2), respectively.

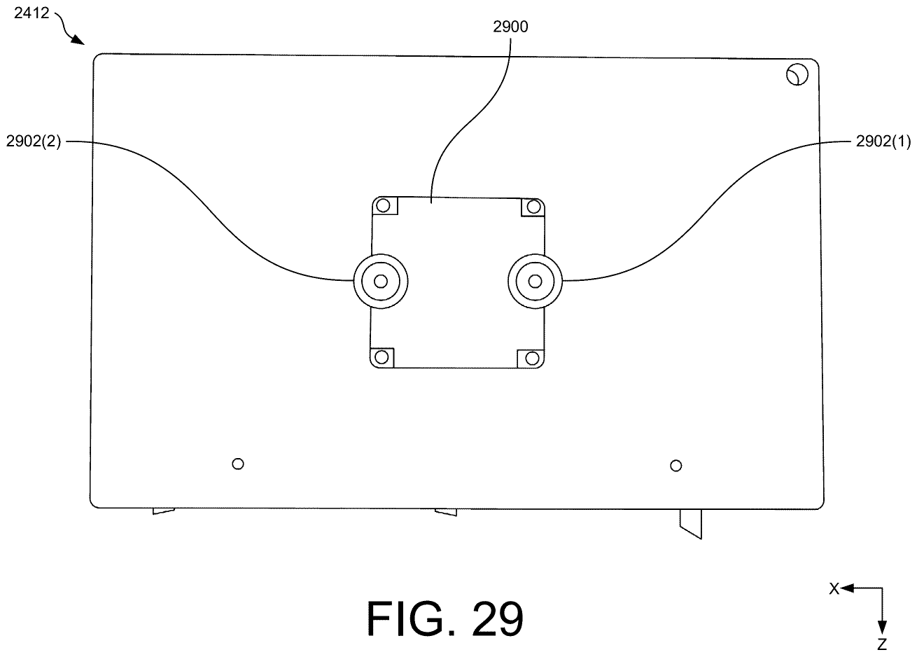

FIG. 29 illustrates a rear view of the display 2412, according to an embodiment of the present disclosure. A plate 2900 may be coupled to a rear surface (i.e., opposite a display surface) of the display 2412. The plate 2900 may be coupled to the display 2412 via adhesives, fasteners, etc. The first fasteners 2222(1) may be threaded into the plate 2900. Posts (e.g., shafts) of the first fasteners 2222(1) may be disposed through the first channel 2700 and the channel 2224(1), as well as the second channel 2702 and the channel 2224(2), respectively. Therein, nuts 2902 (e.g., wing nuts) may fasten onto the posts of the first fasteners 2222(1) to couple the display 2412 to the lid 404.

Prior to tightening the nuts 2902, such as a first nut 2902(1) and a second nut 2902(2), the posts of the first fasteners 2222(1) may be translated within the channels 2224 to reorient, reposition, etc., the display 2412. Once in a desired position, the nuts 2902 may be fastened to secure the display 2412.

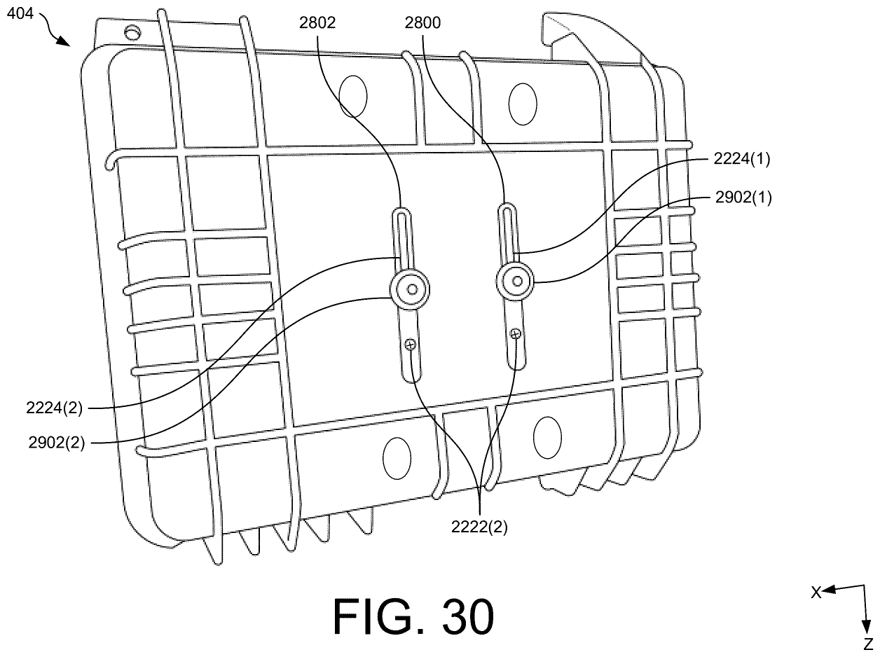

FIG. 30 illustrates the bracket 2220 coupling the display 2412 to the case 400, according to an embodiment of the present disclosure. As introduced above, the second fasteners 2222(2) may be used to couple the first segment 2800 and the second segment 2802 of the bracket 2220 to the lid 404. The first fasteners 2222(1) may be disposed through the first channel 2700 and the channel 2224(1), as well as the second channel 2702 and the channel 2224(2), respectively. Prior to tightening the nuts 2902, the first fasteners 2222(1) may move within the first channel 2700 and the channel 2224(1), as well as the second channel 2702 and the channel 2224(2), respectively, to adjust an orientation, position, etc., of the display 2412.

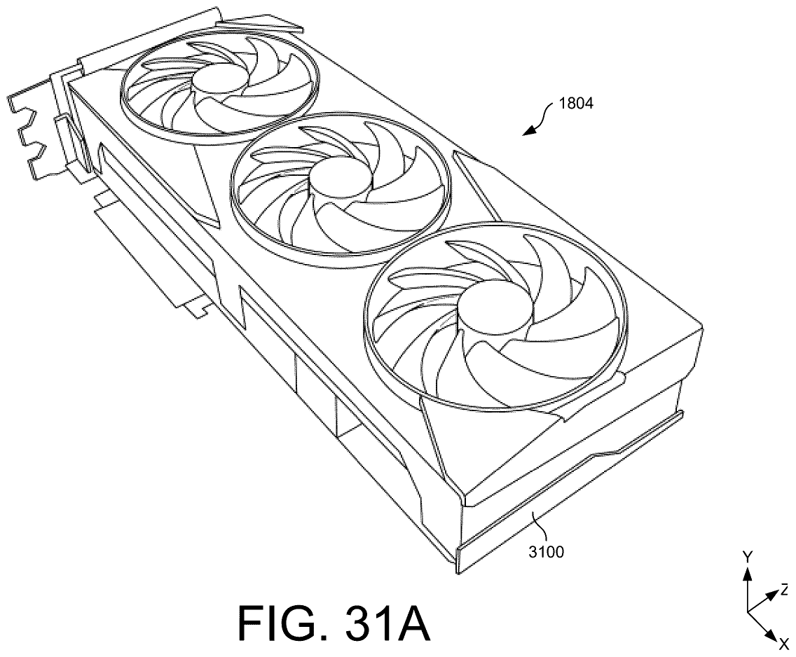

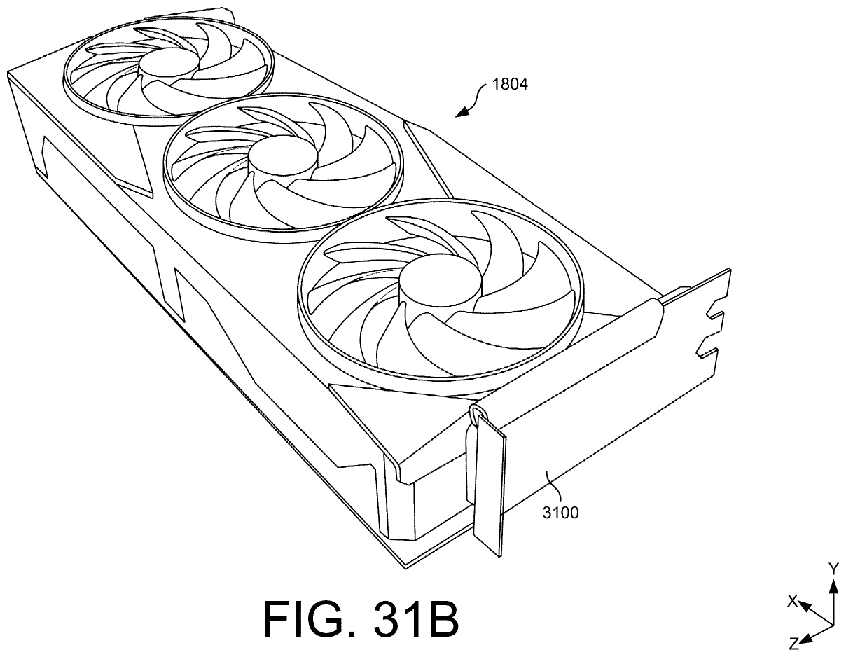

FIGS. 31A and 31B illustrate perspective views of the GPU 1804, according to an embodiment of the present disclosure. The GPU 1804 may be disposed on, or coupled to, a frame 3100. The frame 3100 may couple to the housing 108 for securing the GPU 1804 within the housing 108.

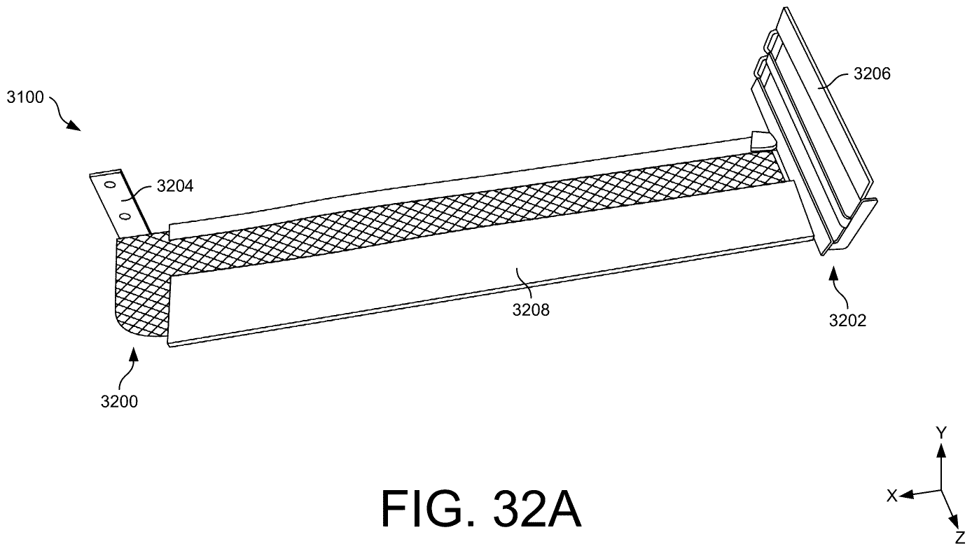

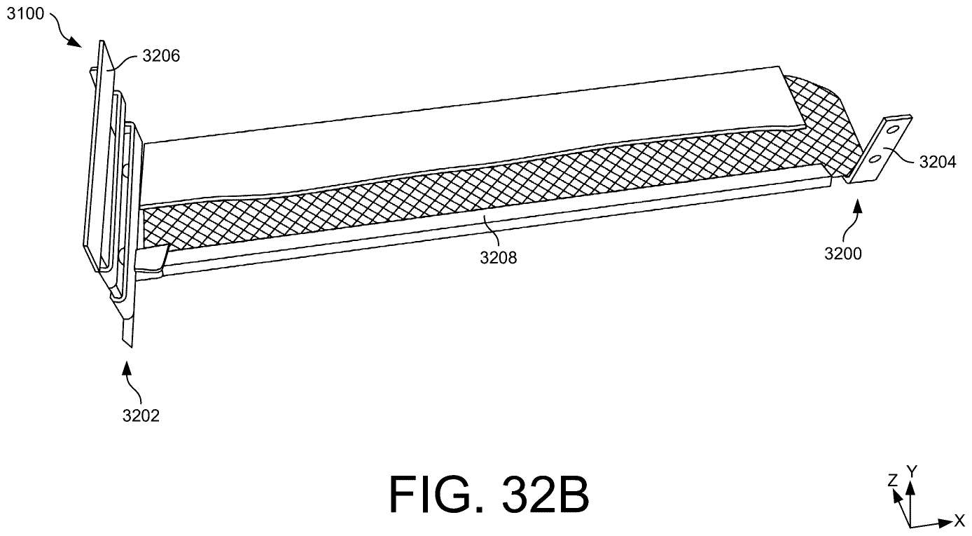

FIGS. 32A and 32B illustrate the frame 3100, showing the GPU 1804 removed, according to an embodiment of the present disclosure. The frame 3100 includes a first end 3200 and a second end 3202 spaced apart from the first end 3200. The first end 3200 may include an arm 3204 that is used to secure the frame 3100 to the housing 108. The second end 3202 may include a flange 3206 that is used to secure the frame 3100 to the housing 108. In an embodiment, fasteners may be disposed through the arm 3204 and the flange 3206 for coupling the frame 3100 to the housing 108.

A plate 3208 may extend between the first end 3200 and the second end 3202. The GPU 1804 may rest on, or couple to, the plate 3208. The plate 3208 may be a meshed material to permit airflow.

While various examples and embodiments are described individually herein, the examples and embodiments may be combined, rearranged, and modified to arrive at other variations within the scope of this disclosure.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. An assembly comprising:
a trolley including:
a frame,
a base pivotably coupled to the frame, the base having:
a channel, and
one or more wheels, and
a coupling mechanism; and
a case configured to removably couple to the trolley, the case including:
a coupling mechanism configured to engage with the coupling mechanism of the trolley to secure the case and the trolley together,
a housing,
a lid rotatably coupled to the housing, and
a flange formed at least in part by the housing and the lid, the flange being disposed adjacent to the channel or within the channel.

2. The assembly of claim 1, wherein:
the case is configured to transition between a closed state and an open state;
the case includes an interior cavity defined by the housing and the lid;
in the closed state, access to the interior cavity is restricted; and
in the open state, access to the interior cavity is permitted.

3. The assembly of claim 1, further comprising:
one or more first computing components disposed within the housing; and
one or more second computing components disposed within the lid, wherein the one or more second computing components are communicatively coupled to the one or more first computing components.

4. The assembly of claim 3, wherein:
the one or more first computing components include at least one of:
a central processing unit (CPU),
a graphics processing unit (GPU),
a motherboard, or
a power supply; and
the one or more second computing components include at least a display.

5. The assembly of claim 1, wherein:
the housing includes:
a front,
a back opposite the front,
a first side, and
a second side opposite the first side; and
the case includes:
one or more first ports located along the front,
a first aperture and a second aperture located along the second side,
a third aperture located along the first side,
second ports located along the second side, the second ports being accessible via the second aperture, and
a power connector located along the first side, the power connector being accessible via the third aperture.

6. The assembly of claim 5, further comprising a fan disposed adjacent to the second aperture.

7. The assembly of claim 5, further comprising:
a first grill located along the back; and
a second grill located along a bottom of the housing.

8. A system comprising:
a trolley; and
a case removably coupled to the trolley, the case being configured to transition between a closed state and an open state, the case including:
a housing,
a lid rotatably coupled to the housing,
first computing components disposed within the housing, the first computing components including at least a central processing unit (CPU), a graphics processing unit (GPU), a power supply, a motherboard, and one or more fans,
at least one second computing component disposed within the lid, the at least one second computing component including a display, the at least one second computing component being communicatively coupled to at least one of the first computing components, and
a grill disposed along a bottom of the housing, the grill permitting an intake of air via the one or more fans.

9. The system of claim 8, further comprising a second grill disposed along a back of the housing, the grill permitting an intake of air via the one or more fans.

10. The system of claim 8, further comprising one or more collapsible feet disposed along the bottom of the housing.

11. The system of claim 8, wherein:
the trolley includes a first coupling mechanism; and
the case includes a second coupling mechanism disposed along the bottom of the housing, the second coupling mechanism engageable with the first coupling mechanism to couple the case to the trolley.

12. The system of claim 8, wherein:
the trolley includes a channel having a first sidewall and a second sidewall; and
the case includes a flange configured to be disposed adjacent to at least one of the first sidewall or the second sidewall.

13. The system of claim 8, wherein:
the CPU, the power supply, the motherboard are located closer to a front of the housing than the GPU;
the power supply is located closer to a first side of the housing than the CPU and the motherboard;
the motherboard is closer to a second side of the housing than the CPU and the power supply, the second side being opposite the first side; and
the CPU is disposed between the power supply and the motherboard.

14. The system of claim 8, further comprising a bracket coupling the display to the lid, wherein the bracket is configured to adjust at an orientation of the display.

15. An assembly including:
a trolley including a first coupling mechanism; and
a case configured to transition between an open state and a closed state, the case including:
a housing,
a lid pivotably coupled to the housing,
a graphics processing unit (GPU) coupled to the housing,
one or more fans disposed within the housing:
a display coupled to the lid,
a second coupling mechanism configured to couple to the first coupling mechanism to secure the case to the trolley, and
one or more grills coupled to the housing, the one or more grills permitting an intake of air into an interior of the housing to cool the GPU.

16. The assembly of claim 15, further comprising a bracket coupling the GPU to the housing.

17. The assembly of claim 15, wherein:
a first grill of the one or more grills is located along a bottom of the housing; and
a second grill of the one or more grills is located along a back of the housing.

18. The assembly of claim 17, further comprising:
one or more standoffs located along the bottom; and
one or more collapsible feet located along the bottom.

19. The assembly of claim 15, wherein:
the housing includes at least a first aperture, a second aperture, and a third aperture;
one or more ports are accessible via the first aperture;
at least one fan of the one or more fans intakes air through the second aperture; and
a power connector is accessible via the third aperture.

20. The assembly of claim 15, wherein:
the trolley includes a channel having a first sidewall and a second sidewall; and
the case includes a flange configured to be disposed adjacent to at least one of the first sidewall or the second sidewall.
